(19) United States
(12) Patent Application Publication
(10) Pub. No.: US 2020/0071503 A1
(43) Pub. Date: Mar. 5, 2020

(54) RESIN COMPOSITION AND RESIN MOLDED ARTICLE

(71) Applicant: FUJI XEROX CO., LTD., Tokyo (JP)

(72) Inventors: Kana MIYAZAKI, Minamiashigara-shi (JP); Ryo TANAKA, Minamiashigara-shi (JP); Kenji YAO, Minamiashigara-shi (JP)

(73) Assignee: FUJI XEROX CO., LTD., Tokyo (JP)

(21) Appl. No.: 16/270,096

(22) Filed: Feb. 7, 2019

(30) Foreign Application Priority Data
Aug. 31, 2018 (JP) 2018-164070

(51) Int. Cl. C08L 1/14

(52) U.S. Cl. CPC C08L 1/14; C08L 2205/06; C08L 2207/53

(57) ABSTRACT

Provided is a resin composition containing: a cellulose acylate (A); a thermoplastic elastomer (B); and metal oxide particles (C).

### CROSS-REFERENCE TO RELATED APPLICATIONS

This application is based on and claims priority under 35 USC 119 from Japanese Patent Application No. 2018-164070 filed on Aug. 31, 2018.

### BACKGROUND

### Technical Field

The present invention relates to a resin composition and a resin molded article.

### Related Art

Patent Document 1 discloses “a resin composition containing a cellulose ester (A), a styrene-based resin (B) and titanium dioxide (C), wherein the content of the component (A) is 95 mass % to 50 mass %, the content of the component (B) is 50 mass % to 5 mass %, the content of the component (C) is 0.1 part by mass to 10 parts by mass per 100 parts by mass of the total amount of the component (A) and the component (B), and a compatibilizer of the component (A) and the component (B) is not contained.”

### CITATION LIST

### Patent Literature

Patent Document 1: JP-A-2013-079319

### SUMMARY

As a resin molded article containing cellulose acylate, for example, a resin molded article containing a cellulose acylate and a thermoplastic elastomer is known, and there is a tendency that dust is likely to adhere to such a resin molded article.

Aspects of non-limiting embodiments of the present disclosure relate to providing a resin composition, from which a resin molded article in which adhesion of dust is suppressed may be obtained, as compared with a case where the resin composition contains only a cellulose acylate (A) and a thermoplastic elastomer (B), in the resin composition containing the cellulose acylate.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a resin composition contains a cellulose acylate (A),

a thermoplastic elastomer (B), and

metal oxide particles (C).

### DETAILED DESCRIPTION

Hereinafter, an exemplary embodiment which is an example of the present invention is described. These descriptions and examples are illustrative of the exemplary embodiments and do not limit the scope of the exemplary embodiments.

In the exemplary embodiment, a numerical value indicated by using “to” indicates a range including the numerical values described before and after “to” as the minimum value and the maximum value, respectively.

In the numerical ranges described in the exemplary embodiment in stages, the upper limit value or the lower limit value described in one numerical range may be replaced by the upper limit value or the lower limit value of the numerical range of another numerical range. In addition, in the numerical range described in the exemplary embodiment, the upper limit value or the lower limit value of the numerical value range may be replaced by the values shown in the examples.

In the exemplary embodiment, the term “step” is not only an independent step but also included in the terms of the present disclosure as long as the intended purpose of the step is achieved even when it cannot be clearly distinguished from other steps.

In the exemplary embodiment, each component may contain a plurality of corresponding substances. In the exemplary embodiment, in a case of referring to the amount of each component in a composition, it means the total amount of the plurality of substances present in the composition when there are a plurality of substances corresponding to each component in the composition, unless otherwise specified.

In the exemplary embodiment, “(meth)acryl” means at least one of acryl and methacryl, and “(meth)acrylate” means at least one of acrylate and methacrylate.

In the exemplary embodiment, the cellulose acylate (A), the thermoplastic elastomer (B), the metal oxide particles (C) and the plasticizer (D) are also referred to as component (A), component (B), component (C) and component (D), respectively.

### <Resin Composition>

The resin composition according to the exemplary embodiment includes a cellulose acylate (A), a thermoplastic elastomer (B), and metal oxide particles (C). The resin composition according to the exemplary embodiment may contain a plasticizer (D), other component (E), or the like, if necessary.

As a resin molded article formed by molding a resin composition containing cellulose acylate, for example, a resin molded article formed by molding a resin composition obtained by mixing a cellulose acylate and a thermoplastic elastomer is known. There is a tendency that dust is likely to adhere such a resin molded article.

According to the resin composition according to the exemplary embodiment, a resin molded article in which adhesion of dust is suppressed may be obtained. The reason therefor is not clear, but it is presumed as follows.

The cellulose acylate is rich in the carbonyl carbon of the ester group and regularly arranged. On the other hand, the metal oxide particle has a lot of oxygen atoms. Therefore, when the composition is kneaded with a composition containing a cellulose acylate, a thermoplastic elastomer, and a metal oxide particle, since the metal oxide particle is attracted to the thermoplastic elastomer, the dispersibility in the resin composition is improved. Further, in the resin molded article formed by molding the resin composition containing the cellulose acylate, the thermoplastic elastomer, and the metal oxide particle, the dispersion of the metal oxide particles is good. Therefore, in the resin molded article, the dispersibility of the metal oxide particle is improved, and the interaction between the cellulose acylate and the metal oxide particle is well exerted. As a result, it is considered that the electrical properties of the resin molded article are changed, and as a result, it is presumed that adhesion of dust to the resin molded article is suppressed.

As the dispersion state of the metal oxide particles in the resin composition and the resin molded article, it is desirable that the metal oxide fine particle is distributed and dispersed nearly uniformly. When agglomerated in part, there is a place where there is no metal oxide, and there is a tendency that dust tends to adhere easily. A measurement method of the dispersion state may be visualized by using the SEM-EDS analysis method combining the EDS detector with a scanning electron microscope and mapping the metal element distribution in the surface and a cut cross section of a resin pellet or molded article.

Hereinafter, the components of the resin composition according to the exemplary embodiment are described in detail.

### [Cellulose Acylate (A): Component (A)]

The cellulose acylate (A) is a cellulose derivative in which at least a part of hydroxyl groups in the cellulose are substituted (acylated) with an acyl group. The acyl group is a group having a structure of —CO—R^{AC} (R^{AC} represents a hydrogen atom or a hydrocarbon group).

The cellulose acylate (A) is, for example, a cellulose derivative represented by the following General Formula (CA).

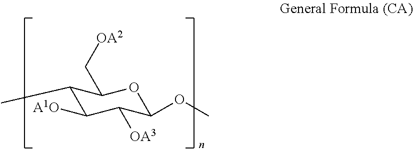

In the General Formula (CA), A¹, A² and A³ each independently represent a hydrogen atom or an acyl group, and n represents an integer of 2 or more. However, at least a part of n A¹, n A² and n A³ represents an acyl group. All of n A¹ in the molecule may be the same, partly the same or different from each other. Similarly, all of n A² and n A³ in the molecule may be the same, partly the same or different from each other.

The hydrocarbon group in the acyl group represented by A¹, A² and A³ may be linear, branched or cyclic, and is preferably linear or branched, and more preferably linear.

The hydrocarbon group in the acyl group represented by A¹, A² and A³ may be a saturated hydrocarbon group or an unsaturated hydrocarbon group, and more preferably a saturated hydrocarbon group.

The acyl group represented by A¹, A² and A³ is preferably an acyl group having 1 to 6 carbon atoms. That is, the cellulose acylate (A) preferably has an acyl group with 1 to 6 carbon atoms. A resin molded article in which adhesion of dust is suppressed may be more easily obtained from the cellulose acylate (A) having an acyl group with 1 to 6 carbon atoms, than a cellulose acylate (A) having an acyl group with 7 or more carbon atoms.

The acyl group represented by A¹, A² and A³ may be a group in which a hydrogen atom in the acyl group is substituted with a halogen atom (e.g., a fluorine atom, a bromine atom and an iodine atom), an oxygen atom, a nitrogen atom or the like, and is preferably unsubstituted.

Examples of the acyl group represented by A¹, A² and A³ include a formyl group, an acetyl group, a propionyl group, a butyryl group (a butanoyl group), a propenoyl group, and a hexanoyl group. Of these, the acyl group is preferably an acyl group having 2 to 4 carbon atoms, and more preferably an acyl group having 2 or 3 carbons, from the viewpoints of obtaining moldability of the resin composition and suppressing adhesion of dust to the resin molded article.

Examples of the cellulose acylate (A) include a cellulose acetate (cellulose monoacetate, cellulose diacetate (DAC), and cellulose triacetate), a cellulose acetate propionate (CAP), and a cellulose acetate butyrate (CAB).

As the cellulose acylate (A), a cellulose acetate propionate (CAP) and a cellulose acetate butyrate (CAB) are preferred, and a cellulose acetate propionate (CAP) is more preferred from the viewpoint of suppressing adhesion of dust to the resin molded article.

The cellulose acylate (A) may be used alone, or may be used in combination of two or more thereof.

The cellulose acylate (A) preferably has a weight-average polymerization degree of 200 to 1000, more preferably 500 to 1000, and still more preferably 600 to 1000 from the viewpoint of obtaining the moldability of the resin composition, and suppressing adhesion of dust to the resin molded article.

The weight-average polymerization degree of the cellulose acylate (A) is determined from the weight average molecular weight (Mw) by the following procedures.

First, the weight average molecular weight (Mw) of the cellulose acylate (A) is measured in terms of polystyrene by a gel permeation chromatography apparatus (GPC apparatus: HLC-8320 GPC manufactured by Tosoh Corporation, column: TSK gel α-M) using tetrahydrofuran.

Subsequently, the degree of polymerization of the cellulose acylate (A) is determined by dividing by the molecular weight of the monomer of cellulose acylate (A). For example, in a case where the substituent of the cellulose acylate is an acetyl group, the molecular weight of the monomer is 263 when the degree of substitution is 2.4 and is 284 when the degree of substitution is 2.9.

The cellulose acylate (A) preferably has a degree of substitution of 2.1 to 2.9, more preferably 2.2 to 2.9, still more preferably 2.3 to 2.9, and particularly preferably 2.6 to 2.9, from the viewpoints of obtaining moldability of the resin composition and suppressing adhesion of dust to the resin molded article.

In the cellulose acetate propionate (CAP), a ratio of the degree of substitution of the acetyl group to the propionyl group (acetyl group/propionyl group) is preferably 0.01 to 1, and more preferably 0.05 to 0.1, from the viewpoints of obtaining moldability of the resin composition and suppressing adhesion of dust to the resin molded article.

The CAP preferably satisfies at least one of the following (1), (2), (3) and (4), more preferably satisfies the following (1), (3) and (4), and still more preferably satisfies the following (2), (3) and (4).

(1) When measured by the GPC method using tetrahydrofuran as a solvent, the weight average molecular weight (Mw) in terms of polystyrene is 160,000 to 250,000, and a ratio Mn/Mz of a number average molecular weight (Mn) in terms of polystyrene to a Z average molecular weight (Mz) in terms of polystyrene is 0.14 to 0.21.
(2) When measured by the GPC method using tetrahydrofuran as a solvent, the weight average molecular weight (Mw) in terms of polystyrene is 160,000 to 250,000, a ratio Mn/Mz of a number average molecular weight (Mn) in terms of polystyrene to a Z average molecular weight (Mz) in terms of polystyrene is 0.14 to 0.21, and a ratio Mw/Mz of a weight average molecular weight (Mw) in terms of polystyrene to the Z average molecular weight (Mz) in terms of polystyrene is 0.3 to 0.7.
(3) When measured with a capillography at a condition of 230° C. according to ISO 11443:1995, a ratio η1/η2 of a viscosity η1 (Pa·s) at a shear rate of 1216 (/sec) to a viscosity η2 (Pa·s) at a shear rate of 121.6 (/sec) is 0.1 to 0.3.
(4) When a small square plate test piece (D11 test piece specified by JIS K7139:2009, 60 mm×60 mm, thickness 1 mm) obtained by injection molding of the CAP is allowed to stand in an atmosphere at a temperature of 65° C. and a relative humidity of 85% for 48 hours, both an expansion coefficient in an MD direction and an expansion coefficient in a TD direction are 0.4% to 0.6%. Here, the MD direction means the length direction of the cavity of the mold used for injection molding, and the TD direction means the direction orthogonal to the MD direction.

In the cellulose acetate butyrate (CAB), a ratio of degree of substitution of the acetyl group to the butyryl group (acetyl group/butyryl group) is preferably 0.05 to 3.5, and more preferably 0.5 to 3.0 from the viewpoints of obtaining moldability of the resin composition and suppressing adhesion of dust to the resin molded article.

The degree of substitution of the cellulose acylate (A) is an index indicating the degree to which the hydroxyl group of cellulose is substituted with an acyl group. That is, the degree of substitution is an index indicating the degree of acylation of the cellulose acylate (A). Specifically, the degree of substitution means the intramolecular average of the number of substitution in which three hydroxyl groups in a D-glucopyranose unit of the cellulose acylate are substituted with the acyl group. The degree of substitution is determined from a ratio of integrated peaks of cellulose-derived hydrogen to acyl group-derived hydrogen with ¹H-NMR (JMN-ECA, manufactured by JEOL RESONANCE Co., Ltd.).

### [Thermoplastic Elastomer (B): Component (B)]

The component (B) is at least one thermoplastic elastomer selected from the group consisting of:

a core-shell structure polymer (b1), which includes a core layer containing a butadiene polymer, and a shell layer containing a polymer selected from a styrene polymer and an acrylonitrile-styrene polymer on the surface of the core layer;

a core-shell structure polymer (b2), which includes a core layer and a shell layer containing an alkyl (meth)acrylate polymer on the surface of the core layer;

an olefin polymer (b3), which is a polymer of an α-olefin and an alkyl (meth)acrylate and contains 60 mass % or more of monomers derived from the α-olefin;

a styrene-ethylene-butadiene-styrene copolymer (b4);

a polyurethane (b5); and

a polyester (b6).

The component (B) is, for example, a thermoplastic elastomer having elasticity at ordinary temperature (25° C.) and softening at a high temperature like a thermoplastic resin.

As described above, when the thermoplastic elastomer (B) is included in the resin composition, the dispersibility of the metal oxide particles (C) is improved, and adhesion of dust to the resin molded body is suppressed. When the thermoplastic elastomer (B) is a core-shell structure polymer, the metal oxide particles (C) are more likely to be dispersed together with the thermoplastic elastomer, and the dispersibility is improved with respect to the cellulose acylate (A). Therefore, when the cellulose acylate (A), the thermoplastic elastomer (B), and the metal oxide particles (C) are kneaded, it is considered that the metal oxide particles (C) are dispersed so as to be attracted to the dispersion of the core-shell structure polymer. On the other hand, when the thermoplastic elastomer (B) is a polymer other than the core-shell structure polymer and is a linear or branched polymer, it is considered that the thermoplastic elastomer (B) exhibits adhesiveness to the metal oxide particles (C). Therefore, when the cellulose acylate (A), the thermoplastic elastomer (B), and the metal oxide particles (C) are kneaded, it is considered that the metal oxide particles (C) are dispersed so as to be attracted to the dispersion of the linear or branched polymer.

(Core-Shell Structure Polymer (b1): Component (b1))

The core-shell structure polymer (b1) is a core-shell structure polymer with a core layer and a shell layer on the surface of the core layer.

The core-shell structure polymer (b1) is a polymer having a core layer as the innermost layer and a shell layer as the outermost layer (specifically, a shell layer polymer obtained by grafting and polymerizing a styrene polymer or an acrylonitrile-styrene polymer to a core layer containing a butadiene polymer).

One or more other layers (for example, one to six other layers) may be provided between the core layer and the shell layer. When another layer is provided, the core-shell structure polymer (b1) is a multi-layer polymer obtained by grafting and polymerizing a plurality of polymers to a core layer polymer.

The core layer containing a butadiene polymer is not particularly limited as long as it contains a polymer obtained by polymerizing a component containing butadiene, and may be a core layer containing a homopolymer of butadiene, or a core layer containing a copolymer of butadiene and another monomer. When the core layer contains a copolymer of butadiene and another monomer, examples of another monomer include vinyl aromatic monomers. Of the vinyl aromatic monomers, styrene components (for example, styrene, an alkyl-substituted styrene (for example, α-methylstyrene, 2-methyl styrene, 3-methyl styrene, 4-methyl styrene, 2-ethyl styrene, 3-ethyl styrene, and 4-ethyl styrene), and a halogen-substituted styrene (for example, 2-chlorostyrene, 3-chlorostyrene, and 4-chlorostyrene)) are preferred. The styrene component may be used alone, or may be used in combination of two or more thereof. Of these styrene components, styrene is preferably used. In addition, polyfunctional monomers such as an allyl (meth)acrylate, a triallyl isocyanurate, and divinylbenzene may be used as another monomer.

Specifically, the core layer containing a butadiene polymer may be, for example, a homopolymer of butadiene, a copolymer of butadiene and styrene, or a terpolymer of butadiene, styrene and divinylbenzene.

The butadiene polymer contained in the core layer contains 60 mass % to 100 mass % (preferably, 70 mass % to 100 mass %) of monomers derived from butadiene and 0 mass % to 40 mass % (preferably, 0 mass % to 30 mass %) of monomers derived from another type of monomer (preferably, a styrene component). For example, the percentage of the monomers derived from each monomer constituting the butadiene polymer is 60 mass % to 100 mass % for butadiene and 0 mass % to 40 mass % for styrene, as each monomer. The percentage is preferably 0 mass % to 5 mass % for divinylbenzene based on the total amount of styrene and divinylbenzene.

The shell layer containing a styrene polymer is not particularly limited as long as it is a shell layer containing a polymer obtained by polymerizing a styrene component, and may be a shell layer containing a homopolymer of styrene, or a shell layer containing a copolymer of styrene and another monomer. Examples of the styrene component include the styrene component as exemplified for the core layer. Examples of other monomer include alkyl (meth)acrylates (for example, methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, and octadecyl (meth)acrylate), or the like. In the alkyl (meth)acrylate, at least a part of the hydrogen of the alkyl chain may be substituted. Examples of the substituent include an amino group, a hydroxy group, a halogen group, or the like. The alkyl (meth)acrylate may be used alone, or may be used in combination of two or more thereof. In addition, polyfunctional monomers such as an allyl (meth)acrylate, a triallyl isocyanurate, and divinylbenzene may be used as another monomer. The styrene polymer contained in the shell layer is preferably a copolymer of a styrene component in an amount of 85 mass % to 100 mass % and another monomer component (preferably, an alkyl (meth)acrylate) in an amount of 0 mass % to 15 mass %.

Of these, the styrene polymer contained in the shell layer is preferably a copolymer of styrene and an alkyl (meth)acrylate from the viewpoint of suppressing adhesion of dust to the resin molded article. From the same viewpoint, a copolymer of styrene and an alkyl (meth)acrylate having an alkyl chain with 1 to 8 carbon atoms is preferred, and an alkyl (meth)acrylate polymer having an alkyl chain with 1 to 4 carbon atoms is more preferred.

The shell layer containing an acrylonitrile-styrene polymer is a shell layer containing a copolymer of an acrylonitrile component and a styrene component. The acrylonitrile-styrene polymer is not particularly limited and examples thereof include a known acrylonitrile-styrene polymer. Examples of the acrylonitrile-styrene polymer include a copolymer of an acrylonitrile component in an amount of 10 mass % to 80 mass % and a styrene component in an amount of 20 mass % to 90 mass %. Examples of the styrene component copolymerizing with the acrylonitrile component include the styrene component as exemplified for the core layer. Polyfunctional monomers such as an allyl (meth)acrylate, a triallyl isocyanurate, divinylbenzene or the like may be used as the acrylonitrile-styrene polymer contained in the shell layer.

One or more other layers between the core layer and the shell layer are exemplified by the polymer layer described in the shell layer.

The mass percentage of the shell layer to the entire core-shell structure is preferably 1 mass % to 40 mass %, more preferably 3 mass % to 30 mass %, and still more preferably 5 mass % to 15 mass %.

Of the component (b1), examples of the commercially available product of the core-shell structure polymer (b1) including a core layer containing a butadiene polymer and a shell layer containing a styrene polymer on the surface of core layer include “METABLEN” (registered trademark) manufactured by Mitsubishi Chemical Corporation, “Kane Ace” (Registered trademark) manufactured by Kaneka Corporation, “Clearstrength” (registered trademark) manufactured by Arkema, and “PARALOID” (Registered trademark) manufactured by the Dow Chemical Japan.

In addition, of the component (b1), examples of the commercially available product of the core-shell structure polymer (b1) including a core layer containing a butadiene polymer and a shell layer containing an acrylonitrile-styrene polymer on the surface of core layer include “Blendex” (registered trademark) manufactured by Galata Chemicals, “ELIX” manufactured by ELIX POLYMERS, or the like.

(Core-Shell Structure Polymer (b2): Component (b2))

The core-shell structure polymer (b2) is a core-shell structure polymer with a core layer and a shell layer on the surface of the core layer.

The core-shell structure polymer (b2) is a polymer having a core layer as the innermost layer and a shell layer as the outermost layer (specifically, a shell layer polymer obtained by grafting and polymerizing an alkyl (meth)acrylate polymer to a core layer polymer).

One or more other layers (for example, one to six other layers) may be provided between the core layer and the shell layer. When another layer is provided, the core-shell structure polymer (b2) is a multi-layer polymer obtained by grafting and polymerizing a plurality of polymers to a core layer polymer.

The core layer is not particularly limited, and is preferably a rubber layer. Examples of the rubber layer include a layer of a (meth)acrylic rubber, a silicone rubber, a styrene rubber, a conjugated diene rubber, an α-olefin rubber, a nitrile rubber, a urethane rubber, a polyester rubber, a polyamide rubber, and a copolymer rubber of two or more of the above rubbers. Of these, the rubber layer is preferably a layer of a (meth)acrylic rubber, a silicone rubber, a styrene rubber, a conjugated diene rubber, an α-olefin rubber, and a copolymer rubber of two or more of the above rubbers.

The rubber layer may be obtained by copolymerizing and crosslinking agents (divinylbenzene, allyl acrylate, butylene glycol diacrylate or the like).

Examples of the (meth)acrylic rubber include a polymer rubber obtained by polymerizing a (meth)acrylic component (for example, alkyl esters of (meth)acrylic acid having 2 to 8 carbon atoms).

Examples of the silicone rubber include a rubber containing a silicone component (polydimethylsiloxane, polyphenylsiloxane, or the like).

Examples of the styrene rubber include a polymer rubber obtained by polymerizing a styrene component (styrene, α-methylstyrene, or the like).

Examples of the conjugated diene rubber include a polymer rubber obtained by polymerizing a conjugated diene component (butadiene, isoprene, or the like).

Examples of the α-olefin rubber include a polymer rubber obtained by polymerizing an α-olefin component (ethylene, propylene, and 2-methylpropylene).

Examples of the copolymer rubber include a copolymer rubber obtained by polymerizing two or more of (meth)acrylic components, a copolymer rubber obtained by polymerizing two or more of (meth)acrylic components, a copolymer of a (meth)acrylic component, a conjugated diene component and a styrene component, or the like.

Examples of the alkyl (meth)acrylate in the polymer constituting the shell layer include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, octadecyl (meth)acrylate, or the like. In the alkyl (meth)acrylate, at least a part of the hydrogen of the alkyl chain may be substituted. Examples of the substituent include an amino group, a hydroxyl group, a halogen group, or the like.

Of these, the alkyl (meth)acrylate polymer is preferably an alkyl (meth)acrylate polymer having an alkyl chain with 1 to 8 carbon atoms, more preferably an alkyl (meth)acrylate polymer having an alkyl chain with 1 to 2 carbon atoms, and still more preferably an alkyl (meth)acrylate polymer having an alkyl chain with 1 carbon atom, from the viewpoint of suppressing adhesion of dust to the resin molded article.

The polymer constituting the shell layer may be, in addition to the alkyl (meth)acrylate, a polymer obtained by polymerizing at least one selected from a glycidyl group-containing vinyl compound and an unsaturated dicarboxylic anhydride.

Examples of the glycidyl group-containing vinyl compound include glycidyl (meth)acrylate, glycidyl itaconate, diglycidyl itaconate, allyl glycidyl ether, styrene-4-glycidyl ether, 4-glycidyl styrene, or the like.

Examples of the unsaturated dicarboxylic anhydride include maleic anhydride, itaconic anhydride, glutaconic anhydride, citraconic anhydride, aconitic anhydride, or the like. Of these, maleic anhydride is preferred.

One or more other layers between the core layer and the shell layer are exemplified by the polymer layer described in the shell layer.

The mass percentage of the shell layer to the entire core-shell structure is preferably 1 mass % to 40 mass %, more preferably 3 mass % to 30 mass %, and still more preferably 5 mass % to 15 mass %.

The core-shell structure polymer (b2) may be prepared by a known method.

Examples of the known method include an emulsion polymerization method. Specifically, the following method is exemplified as a manufacturing method. First, a mixture of monomers is subjected to emulsion polymerization to prepare core particles (core layer), and thereafter a mixture of other monomers is subjected to emulsion polymerization in the presence of the core particles (core layer) to prepare a core-shell structure polymer forming a shell layer around the core particles (core layer).

In addition, when another layer is formed between the core layer and the shell layer, the emulsion polymerization of the mixture of other monomers is repeated to obtain a desired core-shell structure polymer including a core layer, another layer and a shell layer.

Examples of the commercially available product of the core-shell structure polymer (b2) include “METABLEN” (Registered trademark) manufactured by Mitsubishi Chemical Corporation, “Kane Ace” (Registered trademark) manufactured by Kaneka Corporation, “PARALOID” (Registered trademark) manufactured by the Dow Chemical Japan, “STAPHYLOID” (Registered trademark) manufactured by Aica Kogyo Company, Limited, “Paraface” (Registered trademark) manufactured by KURARAY CO., LTD., or the like.

The average primary particle diameter of the core-shell structure polymer (b1) and the core-shell structure polymer (b2) is not particularly limited, and is preferably 50 nm to 500 nm, more preferably 50 nm to 400 nm, still more preferably 100 nm to 300 nm, and particularly preferably 150 nm to 250 nm, from the viewpoint of the puncture impact strength of the obtained resin molded article.

The average primary particle diameter refers to a value measured by the following method. Particles are observed with a scanning electron microscope, the maximum diameter of the primary particles is taken as the primary particle diameter, and the primary particle diameter of 100 particles is measured and averaged to obtain the average primary particle diameter. Specifically, the average primary particle diameter is obtained by observing the dispersed form of the core-shell structure polymer in the resin composition with a scanning electron microscope.

(Olefin Polymer (b3): Component (b3))

The olefin polymer (b3) is a polymer of an α-olefin and an alkyl (meth)acrylate and preferably contains 60 mass % or more of monomers derived from the α-olefin.

Examples of the α-olefin in the olefin polymer include ethylene, propylene, 2-methylpropylene, or the like. An α-olefin having 2 to 8 carbon atoms is preferred, and an α-olefin having 2 to 3 carbon atoms is more preferred, from the viewpoint of suppressing adhesion of dust to the resin molded article. Of these, ethylene is still more preferred.

Examples of the alkyl (meth)acrylate polymerizing with the α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, octadecyl (meth)acrylate, or the like. From the viewpoint of suppressing adhesion of dust to the resin molded article, an alkyl (meth)acrylate having an alkyl chain with 1 to 8 carbon atoms is preferred, an alkyl (meth)acrylate having an alkyl chain with 1 to 4 carbon atoms is more preferred, and an alkyl (meth)acrylate having an alkyl chain with 1 to 2 carbon atoms is still more preferred.

Here, the olefin polymer is preferably a polymer of ethylene and methyl acrylate, from the viewpoint of suppressing adhesion of dust to the resin molded article.

The olefin polymer preferably contains 60 mass % to 97 mass % of and more preferably 70 mass % to 85 mass % of monomers derived from the α-olefin, from the viewpoint of suppressing adhesion of dust to the resin molded article.

The olefin polymer may contain the structural unit derived from the α-olefin and another structural unit derived from an alkyl (meth)acrylate. However, another structural unit is preferably 10 mass % or less based on all the structural units in the olefin polymer.

(Styrene-Ethylene-Butadiene-Styrene Copolymer (b4): Component (b4))

The copolymer (b4) is not particularly limited as long as it is a thermoplastic elastomer, and examples thereof include a styrene-ethylene-butadiene-styrene copolymer. The copolymer (b4) may be a styrene-ethylene-butadiene-styrene copolymer and a hydrogenated product thereof.

The copolymer (b4) is preferably a hydrogenated product of the styrene-ethylene-butadiene-styrene copolymer from the viewpoint of suppressing adhesion of dust to the resin molded article. In addition, from the same viewpoint, the copolymer (b4) is preferably a block copolymer, and, for example, is preferably a copolymer (styrene-ethylene/butylene-styrene triblock copolymer) having a block of the styrene portion at both ends and a block of a central portion containing ethylene/butylene by hydrogenating at least a part of the double bond of the butadiene portion. The ethylene/butylene block portion of the styrene-ethylene/butylene-styrene copolymer may be a random copolymer.

The copolymer (b4) is obtained by a known method. When the copolymer (b4) is a hydrogenated product of the styrene-ethylene-butadiene-styrene copolymer, for example, the copolymer may be obtained by hydrogenating the butadiene portion of a styrene-butadiene-styrene block copolymer in which the conjugated diene portion includes a 1,4 bond.

Examples of the commercially available product of the copolymer (b4) include “Kraton” (registered trademark) manufactured by Kraton Corporation, “Septon” (registered trademark) manufactured by Kuraray CO., LTD., or the like.

(Polyurethane (b5): Component (b5))

The polyurethane (b5) is not particularly limited as long as it is a thermoplastic elastomer, and examples thereof include a known polyurethane. The polyurethane (b5) is preferably a linear polyurethane. The polyurethane (b5) is obtained, for example, by reacting a polyol component (a polyether polyol, a polyester polyol, a polycarbonate polyol, or the like), an organic isocyanate component (an aromatic diisocyanate, an aliphatic (including alicyclic) diisocyanate, or the like), and, if necessary, a chain extender (an aliphatic (including alicyclic) diol, or the like). Each of the polyol component and the organic isocyanate component may be used alone, or may be used in combination of two or more thereof.

The polyurethane (b5) is preferably an aliphatic polyurethane from the viewpoint of suppressing adhesion of dust to the resin molded article. The aliphatic polyurethane is preferably obtained, for example, by reacting a polyol component containing a polycarbonate polyol with an isocyanate component containing an aliphatic diisocyanate.

The polyurethane (b5) may be obtained by reacting a polyol component with an organic isocyanate component in a manner that a value of the NCO/OH ratio in the raw material in the synthesis of polyurethane is within a range of 0.90 to 1.5. The polyurethane (b5) is obtained by a known method such as a one-shot method, a prepolymerization method or the like.

Examples of the commercially available product of the polyurethane (b5) include “Estane” (registered trademark) manufactured by Lubrizol Corporation, “Elastollan” (registered trademark) manufactured by BASF, or the like. Examples also include “Desmopan” (registered trademark) manufactured by Bayer, or the like.

(Polyester (b6): Component (b6))

The polyester (b6) is not particularly limited as long as it is a thermoplastic elastomer, and examples thereof include a known polyester. The polyester (b6) is preferably an aromatic polyester from the viewpoint of suppressing adhesion of dust to the resin molded article. In the exemplary embodiment, the aromatic polyester represents a polyester having an aromatic ring in the structure thereof.

Examples of the polyester (b6) include a polyester copolymer (polyether ester, polyester ester, or the like). Specific examples include a polyester copolymer having a hard segment including a polyester unit and a soft segment including a polyester unit; a polyester copolymer having a hard segment including a polyester unit and a soft segment including a polyether unit; and a polyester copolymer having a hard segment including a polyester unit and a soft segment including a polyether unit and a polyester unit. The mass ratio (hard segment/soft segment) of the hard segment to the soft segment in the polyester copolymer is preferably, for example, 20/80 to 80/20. The polyester unit constituting the hard segment and the polyester unit and the polyether unit constituting the soft segment may be either aromatic or aliphatic (including alicyclic).

The polyester copolymer as the polyester (b6) may be obtained by a known method. The polyester copolymer is preferably a linear polyester copolymer. The polyester copolymer is obtained, for example, by esterifying or transesterifying a dicarboxylic acid component having 4 to 20 carbon atoms, a diol component having 2 to 20 carbon atoms and a polyalkylene glycol component having a number average molecular weight of 300 to 20,000 (containing an alkylene oxide adduct of polyalkylene glycols) (an esterification or transesterification method) to produce an oligomer, and thereafter polycondensating the oligomer (a polycondensation method). In addition, examples of the esterification or transesterification method include a method using a dicarboxylic acid component having 4 to 20 carbon atoms, a diol component having 2 to 20 carbon atoms, and an aliphatic polyester component having a number average molecular weight of 300 to 20,000. The dicarboxylic acid component is an aromatic or aliphatic dicarboxylic acid or an ester derivative thereof, the diol component is an aromatic or aliphatic diol, and the polyalkylene glycol component is an aromatic or aliphatic polyalkylene glycol.

Of these, it is preferable to use a dicarboxylic acid component having an aromatic ring as the dicarboxylic acid component of the polyester copolymer, from the viewpoint of suppressing adhesion of dust to the resin molded article. It is preferable to use an aliphatic diol component and an aliphatic polyalkylene glycol component as the diol component and the polyalkylene glycol component, respectively.

Examples of the commercially available product of the polyester (b6) include “PELPRENE” (registered trademark) manufactured by Toyobo Co., Ltd. and “Hytrel” (registered trademark) manufactured by DU PONT-TORAY CO., LTD.

### [Metal Oxide Particles (C): Component (C)]

The metal oxide particles (C) are not particularly limited. From the viewpoint of suppressing adhesion of dust to the resin molded article, the metal oxide particles (C) are preferable an oxide containing at least one metal selected from the group consisting of Ti, Sn, Fe, Cr, Co, V, Al, Bi, Sb, and Ni. The metal oxide particle may be used alone, or may be used in combination of two or more thereof. Further, the metal oxide particle may be a composite oxide.

Specific examples of the metal oxide particle include titanium oxide (TiO₂), tin oxide (SnO₂), iron oxide (Fe₂O₃), copper oxide (CuO), zinc oxide (ZnO), a composite oxide of titanium, antimony and nickel (Ti, Sb, Ni)O₂), a composite oxide of titanium, antimony and chromium (Ti,Sb,Cr)O₂), a composite oxide of cobalt and aluminum (CoAl₂O₄), a composite oxide of bismuth and vanadium (BiVO₄), a composite oxide of cobalt, nickel, zinc and titanium ((Co,Ni,Zn)TiO₄), a composite oxide of cobalt, aluminum and chromium (Co(Al,Cr)₂O₄), a composite oxide of iron, cobalt and chromium ((Co,Fe) (Fe,Cr)₂O₄), a composite oxide of zinc and iron ((Zn,Fe)Fe₂O₄), or the like.

The average particle diameter of the metal oxide particle may be 10 nm to 300 nm, is preferably 30 nm to 200 nm, still more preferably 50 nm to 150 nm, and particularly preferably 50 nm to 100 nm, from the viewpoint of suppressing adhesion of dust to the resin molded article.

The average particle diameter of the metal oxide particle is measured by cutting with a microtome from the resin composition or the resin molded article to be measured, collecting a measurement sample and observing the collected measurement sample by TEM (transmission electron microscope). Then, the diameter of a circle equal to the projected area of each of the 50 particles is taken as the particle diameter, and the average value thereof is taken as the average particle diameter.

### [Plasticizer (D): Component (D)]

Examples of the plasticizer (D) include a cardanol compound, an ester compound, camphor, a metal soap, a polyol, a polyalkylene oxide, or the like. It is considered that the dispersibility of the metal oxide particle is promoted since the plasticizer is included.

In the exemplary embodiment, the ester compound as the plasticizer (D) is excluded from the ester compound represented by the specific General Formula shown as “other component (E)” described later.

The plasticizer (D) may be used alone, or may be used in combination of two or more thereof.

From the viewpoint of suppressing adhesion of dust to the resin molded article, the plasticizer (D) preferably contains at least one selected from the cardanol compound and the ester compound other than the component (E). Hereinafter, the cardanol compound and the ester compound suitable as the plasticizer (D) are specifically described.

### —Cardanol Compound—

The cardanol compound refers to a component (e.g., a compound represented by the following structural formulas (c-1) to (c-4)) contained in a compound naturally derived from cashews or a derivative derived from the above components.

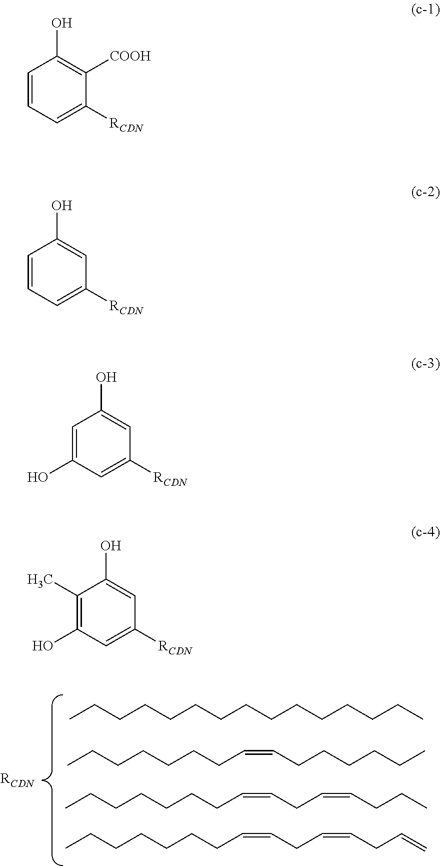

The cardanol compound may be used alone, or may be used in combination of two or more thereof.

The resin composition according to the exemplary embodiment may contain, as the cardanol compound, a mixture of compounds naturally derived from cashews (hereinafter also referred to as “cashew-derived mixture”).

The resin composition according to the exemplary embodiment may contain a derivative from the cashew-derived mixture as the cardanol compound. Examples of the derivative from the cashew-derived mixture include the following mixtures or monomers.

Mixture prepared by adjusting the composition ratio of each component in the cashew-derived mixture

Monomer obtained by isolating only a specific component from the cashew-derived mixture

Mixture containing a modified product obtained by modifying components in the cashew-derived mixture

Mixture containing a polymer obtained by polymerizing a component in the cashew-derived mixture

Mixture containing a modified polymer obtained by modifying and polymerizing a component in the cashew-derived mixture

Mixture containing a modified product obtained by further modifying the components in the mixture whose composition ratio is adjusted

Mixture containing a polymer obtained by further polymerizing the component in the mixture whose composition ratio is adjusted

Mixture containing a modified polymer obtained by further modifying and polymerizing the component in the mixture whose composition ratio is adjusted

Modified product obtained by further modifying the isolated monomer

Polymer obtained by further polymerizing the isolated monomer

Modified polymer obtained by further modifying and polymerizing the isolated monomer

Here, the monomer includes a multimer such as a dimer and a trimer.

The cardanol compound is preferably a compound being at least one selected from the group consisting of a compound represented by a General Formula (CDN1) and a polymer obtained by polymerizing a compound represented by the General Formula (CDN1), from the viewpoint of suppressing adhesion of dust to the resin molded article.

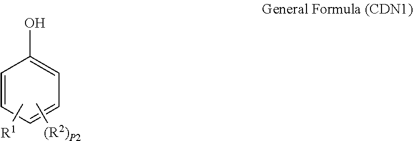

In the General Formula (CDN1), R¹ represents an alkyl group optionally having a substituent, or an unsaturated aliphatic group optionally having a double bond and a substituent. R² represents a hydroxy group, a carboxy group, an alkyl group optionally having a substituent, or an unsaturated aliphatic group optionally having a double bond and a substituent. P2 represents an integer of 0 to 4. When P2 is 2 or more, a plurality of R² may be the same group or different groups.

In the General Formula (CDN1), the alkyl group optionally having a substituent represented by R¹ is preferably an alkyl group having 3 to 30 carbon atoms, more preferably an alkyl group having 5 to 25 carbon atoms, and still more preferably an alkyl group having 8 to 20 carbon atoms.

Examples of the substituent include: a hydroxy group; a substituent containing an ether bond, such as an epoxy group or a methoxy group; a substituent containing an ester bond, such as an acetyl group or a propionyl group; or the like.

Examples of the alkyl group optionally having a substituent include pentadecan-1-yl, heptan-1-yl, octan-1-yl, nonan-1-yl, decan-1-yl, undecan-1-yl, dodecan-1-yl, tetradecan-1-yl, or the like.

In the General Formula (CDN1), the unsaturated aliphatic group optionally having a double bond and a substituent represented by R¹ is preferably an unsaturated aliphatic group having 3 to 30 carbon atoms, more preferably an unsaturated aliphatic group having 5 to 25 carbon atoms, and still more preferably an unsaturated aliphatic group having 8 to 20 carbon atoms.

The number of double bonds contained in the unsaturated aliphatic group is preferably one to three.

Examples of the substituent include those listed as the substituent of the alkyl group.

Examples of the unsaturated aliphatic group optionally having a double bond and a substituent include pentadeca-8-en-1-yl, pentadeca-8,11-dien-1-yl, pentadeca-8,11,14-trien-1-yl, pentadec-7-en-1-yl, pentadeca-7,10-dien-1-yl, pentadeca-7,10,14-trien-1-yl, or the like.

In the General Formula (CDN1), R¹ is preferably pentadeca-8-en-1-yl, pentadeca-8,11-dien-1-yl, pentadeca-8,11,14-trien-1-yl, pentadec-7-en-1-yl, pentadeca-7,10-dien-1-yl, and pentadeca-7,10,14-trien-1-yl.

In the General Formula (CDN1), preferred examples of the alkyl group optionally having a substituent and the unsaturated aliphatic group optionally having a double bond and a substituent, which are represented by R², include those listed as the alkyl group optionally having a substituent and the unsaturated aliphatic group optionally having a double bond and a substituent, which are represented by R′.

The compound represented by the General Formula (CDN1) may be further modified. For example, the compound may be epoxidized. Specifically, the compound may be a compound having a structure in which the hydroxy group of the compound represented by the General Formula (CDN1) is replaced with the following group (EP), i.e., a compound represented by the following General Formula (CDN1-e).

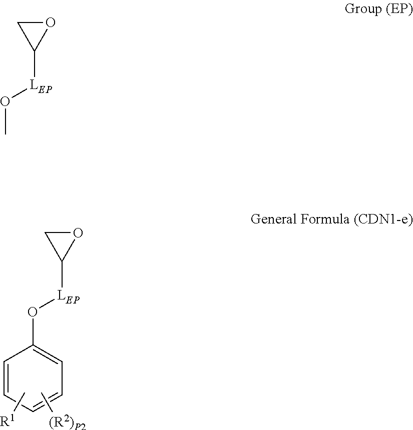

In the group (EP) and the General Formula (CDN1-e), L_{EP} represents a single bond or a divalent linking group. In the General Formula (CDN1-e), R¹, R² and P2 each independently have the same meanings as R¹, R² and P2 in the General Formula (CDN1).

In the group (EP) and the General Formula (CDN1-e), examples of the divalent linking group represented by L_{EP} include an alkylene group optionally having a substituent (preferably an alkylene group having 1 to 4 carbon atoms, and more preferably an alkylene group having 1 carbon atom), —CH₂CH₂OCH₂CH₂—, or the like.

Examples of the substituent include those listed as the substituent for R¹ of the General Formula (CDN1).

L_{EP} is preferably a methylene group.

The polymer obtained by polymerizing a compound represented by the General Formula (CDN1) refers to a polymer obtained by polymerizing at least two compounds represented by the General Formula (CDN1) with or without a linking group.

Examples of the polymer obtained by polymerizing the compound represented by the General Formula (CDN1) include a compound represented by the following General Formula (CDN2).

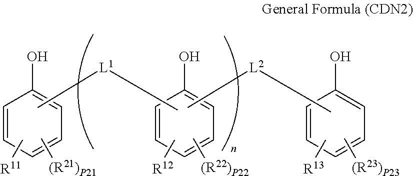

In the General Formula (CDN2), R¹¹, R¹² and R¹³ each independently represent an alkyl group optionally having a substituent, or an unsaturated aliphatic group optionally having a double bond and a substituent. R²¹, R²² and R²³ each independently represent a hydroxy group, a carboxy group, an alkyl group optionally having a substituent, or an unsaturated aliphatic group optionally having a double bond and a substituent. P21 and P23 each independently represent an integer of 0 to 3, and P22 represents an integer of 0 to 2. L¹ and L² each independently represent a divalent linking group. n represents an integer of 0 to 10. A plurality of R²¹ when P21 is 2 or more, a plurality of R²² when P22 is 2 or more, and a plurality of R²³ when P23 is 2 or more may be the same group or different groups, separately. A plurality of R¹², R²², and L¹ when n is 2 or more may be the same group or different groups separately, and a plurality of P22 when n is 2 or more may be the same group or different group.

In the General Formula (CDN2), preferred examples of the alkyl group optionally having a substituent, and the unsaturated aliphatic group optionally having a double bond and a substituent, which are represented by R¹¹, R¹², R¹³, R²¹, R²² and R²³ include those listed for R¹ of the General Formula (CDN1).

In the General Formula (CDN2), examples of the divalent linking group represented by L¹ and L² include an alkylene group optionally having a substituent (preferably an alkylene group having 2 to 30 carbon atoms, and more preferably an alkylene group having 5 to 20 carbon atoms), or the like.

Examples of the substituent include those listed as the substituent for R¹ of the General Formula (CDN1).

In the General Formula (CDN2), n is preferably 1 to 10, and more preferably 1 to 5.

The compound represented by the General Formula (CDN2) may be further modified. For example, the compound may be epoxidized. Specifically, the compound may be a compound having a structure in which the hydroxy group of the compound represented by the General Formula (CDN2) is replaced with the group (EP), i.e., a compound represented by the following General Formula (CDN2-e).

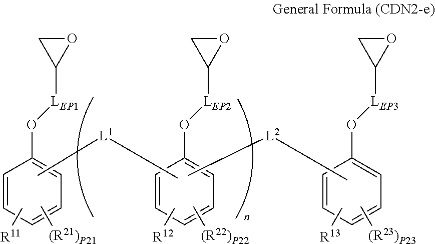

In the General Formula (CDN2-e), R¹¹, R¹², R¹³, R²¹, R²², R²³, P21, P22, P23, L¹, and L² each have the same meaning as R¹¹, R¹², R¹³, R²¹, R²², R²³, P21, P22, P23, L¹, L² and n in the general formula (CDN2).

In the General Formula (CDN2-e), L_{EP1}, L_{EP2} and L_{EP3} each independently represent a single bond or a divalent linking group. When n is 2 or more, a plurality of L_{EP2} may be the same group or different groups.

In the General Formula (CDN2-e), preferred examples of the divalent linking group represented by L_{EP1}, L_{EP2} and L_{EP3} include those listed for the divalent linking group represented by L_{EP} in the General Formula (CDN1-e).

The polymer obtained by polymerizing a compound represented by the General Formula (CDN1) may be, for example, a polymer obtained by three-dimensionally crosslinking and polymerizing at least three compounds represented by the General Formula (CDN1) with or without a linking group. Examples of the polymer obtained by three-dimensionally crosslinking and polymerizing the compound represented by the General Formula (CDN1) include a compound represented by the following structural formula.

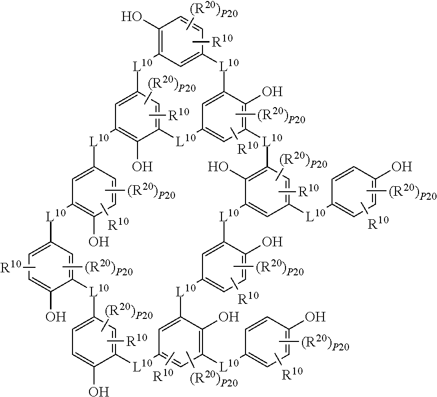

In the above structural formula, R¹⁰, R²⁰ and P20 each independently have the same meanings as R¹, R² and P2 in the General Formula (CDN1). L¹⁰ represents a single bond or a divalent linking group. A plurality of R¹⁰, R²⁰ and L¹⁰ may be the same group or different groups, separately. A plurality of P20 may be the same number or different numbers.

In the above structural formula, examples of the divalent linking group represented by L¹⁰ include an alkylene group optionally having a substituent (preferably an alkylene group having 2 to 30 carbon atoms, and more preferably an alkylene group having 5 to 20 carbon atoms), or the like.

Examples of the substituent include those listed as the substituent for R¹ of the General Formula (CDN1).

The compound represented by the above structural formula may be further modified. For example, the compound may be epoxidized. Specifically, the compound may be a compound having a structure in which the hydroxy group of the compound represented by the above structural formula is replaced by the group (EP), for example, a polymer represented by the following structural formula, i.e., a polymer obtained by three-dimensionally crosslinking and polymerizing the compound represented by the General Formula (CDN1-e).

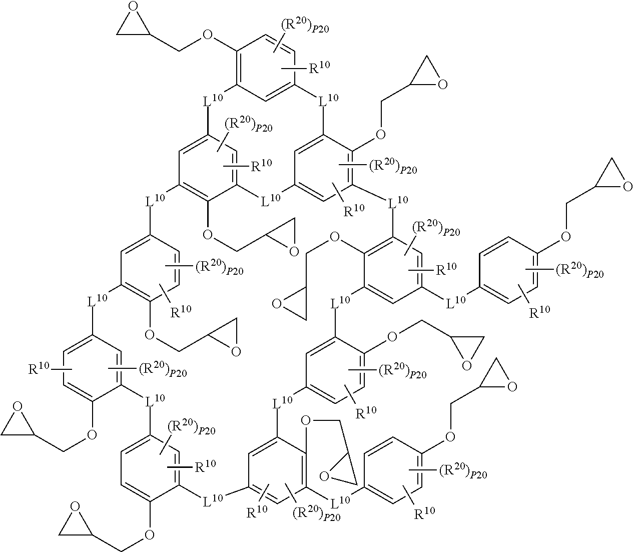

In the above structural formula, R¹⁰, R²⁰ and P20 each independently have the same meanings as R¹, R² and P2 in the General Formula (CDN1-e). L¹⁰ represents a single bond or a divalent linking group. A plurality of R¹⁰, R²⁰ and L¹⁰ may be the same group or different groups, separately. A plurality of P20 may be the same number or different numbers.

In the above structural formula, examples of the divalent linking group represented by L¹⁰ include an alkylene group optionally having a substituent (preferably an alkylene group having 2 to 30 carbon atoms, and more preferably an alkylene group having 5 to 20 carbon atoms), or the like.

Examples of the substituent include those listed as the substituent for R¹ of the General Formula (CDN1).

The cardanol compound preferably contains a cardanol compound having an epoxy group, and is more preferably a cardanol compound having an epoxy group, from the viewpoint of suppressing adhesion of dust to the resin molded article.

A commercially available product may be used as the cardanol compound. Examples of the commercially available product include: NX-2024, Ultra LITE 2023, NX-2026, GX-2503, NC-510, LITE 2020, NX-9001, NX-9004, NX-9007, NX-9008, NX-9201, and NX-9203, manufactured by Cardolite Corporation; LB-7000, LB-7250, and CD-5L manufactured by Tohoku Chemical Industry Co., Ltd.; or the like.

Examples of the commercially available product of the cardanol compound having an epoxy group include NC-513, NC-514S, NC-547, LITE 513E, and Ultra LTE 513 manufactured by Cardolite Corporation.

The cardanol compound preferably has a hydroxyl value of 100 mgKOH/g or more, more preferably 120 mgKOH/g or more, and still more preferably 150 mgKOH/g or more, from the viewpoint of suppressing adhesion of dust to the resin molded article. The hydroxyl value of the cardanol compound is measured according to Method A of ISO14900.

When a cardanol compound having an epoxy group is used as the cardanol compound, an epoxy equivalent is preferably 300 to 500, more preferably 350 to 480, and still more preferably 400 to 470, from the viewpoint of suppressing adhesion of dust to the resin molded article. The epoxy equivalent of the cardanol compound having an epoxy group is measured according to ISO3001.

The cardanol compound preferably has a molecular weight of 250 to 1000, more preferably 280 to 900, and still more preferably 300 to 800, from the viewpoint of suppressing adhesion of dust to the resin molded article.

### —Ester Compound—

The ester compound contained as the plasticizer (D) in the resin composition according to the exemplary embodiment is not particularly limited as long as it is an ester compound other than the compounds represented by the General Formulas (1) to (5) described later. Examples of the plasticizer (D) include a dicarboxylic diester, a citric acid ester, a polyether ester compound, a glycol benzoate, a compound represented by the following General Formula (6), an epoxidized fatty acid ester, or the like. Examples of the ester include a monoester, a diester, a triester, and a polyester.

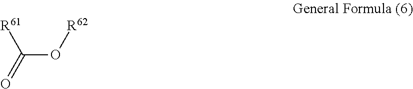

In the General Formula (6), R⁶¹ represents an aliphatic hydrocarbon group having 7 to 28 carbon atoms, and R⁶² represents an aliphatic hydrocarbon group having 1 to 8 carbon atoms.

The specific form and preferred form of the group represented by R⁶¹ include the same form as the group represented by R¹¹ in the General Formula (1).

The group represented by R⁶² may be a saturated aliphatic hydrocarbon group, or an unsaturated aliphatic hydrocarbon group, and is preferably a saturated aliphatic hydrocarbon group. The group represented by R⁶² may be a linear aliphatic hydrocarbon group, a branched aliphatic hydrocarbon group, or an aliphatic hydrocarbon group containing an alicyclic ring, and is preferably a branched aliphatic hydrocarbon group. The group represented by R⁶² may be a group in which a hydrogen atom in the aliphatic hydrocarbon group is substituted with a halogen atom (e.g., a fluorine atom, a bromine atom and an iodine atom), an oxygen atom, a nitrogen atom or the like, and is preferably unsubstituted. The group represented by R⁶² preferably has 2 or more carbon atoms, more preferably 3 or more carbon atoms, and still more preferably 4 or more carbon atoms.

Specific examples of the ester compound contained as the plasticizer (D) include adipates, citrates, sebacates, azelates, phthalates, acetates, dibasiates, phosphates, condensed phosphates, glycol esters (e.g., glycol benzoate), modified products of fatty acid esters (e.g., epoxidized fatty acid esters), or the like. Examples of the above ester include a monoester, a diester, a triester, and a polyester. Of these, dicarboxylic diesters (e.g., adipic acid diester, sebacic acid diester, azelaic acid diester, and phthalic acid diester) are preferred.

The plasticizer (D) is preferably an adipate ester. The adipate ester has high affinity with the cellulose acylate (A), and disperses in a state close to uniformity to the cellulose acylate (A), thereby further improving thermal fluidity as compared with another plasticizer (D).

The ester compound contained as the plasticizer (D) in the resin composition according to the exemplary embodiment preferably has a molecular weight (or a weight average molecular weight) of 200 to 2000, more preferably 250 to 1500, and still more preferably 280 to 1000. The weight average molecular weight of the ester compound is not particularly limited, and is a value measured according to the method of measuring the weight average molecular weight of the cellulose acylate (A).

Examples of the adipate ester include an adipate diester and an adipate polyester. Specifically, examples include an adipate diester represented by the following General Formula (AE) and an adipate polyester represented by the following General Formula (APE).

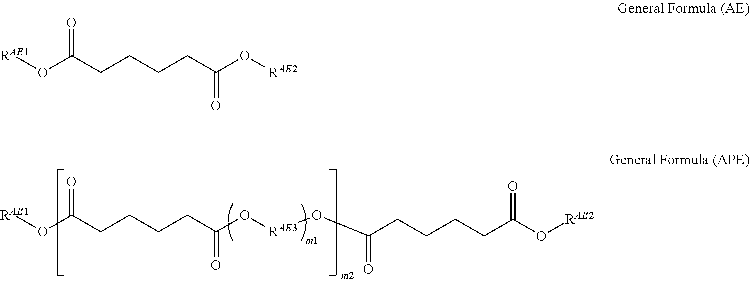

In the General Formula (AE), R^{AE1} and R^{AE2} each independently represent an alkyl group or a polyoxyalkyl group [—(CₓH_{2X}—O)_{y}—R^{A1}] (Here, R^{A1} represents an alkyl group, x represents an integer of 1 to 10, and y represents an integer of 1 to 10.).

In the General Formula (APE), R^{AE1} and R^{AE2} each independently represent an alkyl group or a polyoxyalkyl group [—(CₓH_{2X}—O)_{y}—R^{A1}] (Here, R^{A1} represents an alkyl group, x represents an integer of 1 to 10, and y represents an integer of 1 to 10.), and R^{AE3} represents an alkylene group. m1 represents an integer of 1 to 10, and m2 represents an integer of 1 to 20.

In the General Formula (AE) and the General Formula (APE), the alkyl group represented by R^{AE1} and R^{AE2} is preferably an alkyl group having 1 to 12 carbon atoms, more preferably an alkyl group having 4 to 10 carbon atoms, and still more preferably an alkyl group having 8 carbon atoms. The alkyl group represented by R^{AE1} and R^{AE2} may be linear, branched or cyclic, and is preferably linear or branched.

In the polyoxyalkyl group [—(CₓH_{2X}—O)_{y}—R^{A1}] represented by R^{AE1} and R^{AE2} in the General Formula (AE) and the General Formula (APE), the alkyl group represented by R^{A1} is preferably an alkyl group having 1 to 6 carbon atoms, and more preferably an alkyl group having 1 to 4 carbon atoms. The alkyl group represented by R^{A1} may be linear, branched or cyclic, and is preferably linear or branched.

In the general formula (APE), the alkylene group represented by R^{AE3} is preferably an alkylene group having 1 to 6 carbon atoms, and more preferably an alkylene group having 1 to 4 carbon atoms. The alkylene group may be linear, branched or cyclic, and is preferably linear or branched.

In the General Formula (APE), m1 is preferably an integer of 1 to 5, and m2 is preferably an integer of 1 to 10.

In the General Formula (AE) and the General Formula (APE), the group represented by each symbol may be substituted with a substituent. Examples of the substituent include an alkyl group, an aryl group, a hydroxy group, or the like.

The adipate ester preferably has a molecular weight (weight average molecular weight) of 250 to 2000, more preferably 280 to 1500, and still more preferably 300 to 1000. The weight average molecular weight of the adipate ester is a value measured according to the method of measuring the weight average molecular weight of the cellulose acylate (A).

A mixture of an adipate ester and other components may be used as the adipate ester. Examples of the commercially available product of the mixture include Daifatty 101 manufactured by DAIHACHI CHEMICAL INDUSTRY CO., LTD.

The hydrocarbon group at the end of a fatty acid ester such as citric acid ester, sebacic acid ester, azelaic acid ester, phthalic acid ester, and acetic acid ester is preferably an aliphatic hydrocarbon group, preferably an alkyl group having 1 to 12 carbon atoms, more preferably an alkyl group having 4 to 10 carbons, and still more preferably an alkyl group having 8 carbons. The alkyl group may be linear, branched or cyclic, and is preferably linear or branched.

Examples of the fatty acid esters such as citric acid ester, sebacic acid ester, azelaic acid ester, phthalic acid ester, and acetic acid ester include an ester of a fatty acid and an alcohol. Examples of the alcohol include: monohydric alcohols such as methanol, ethanol, propanol, butanol, and 2-ethylhexanol; polyhydric alcohols such as glycerin, a polyglycerol (diglycerin or the like), pentaerythritol, ethylene glycol, diethylene glycol, propylene glycol, butylene glycol, trimethylolpropane, trimethylol ethane, and a sugar alcohol; or the like.

Examples of the glycol in the glycol benzoate include ethylene glycol, diethylene glycol, propylene glycol, or the like.

The epoxidized fatty acid ester is an ester compound having a structure (i.e., oxacyclopropane) in which an unsaturated carbon-carbon bond of an unsaturated fatty acid ester is epoxidized. Examples of the epoxidized fatty acid ester include an ester of a fatty acid and an alcohol in which part or the entire unsaturated carbon-carbon bond in an unsaturated fatty acid (e.g., oleic acid, palmitoleic acid, vaccenic acid, linoleic acid, linolenic acid, and nervonic acid) is epoxidized. Examples of the alcohol include: monohydric alcohols such as methanol, ethanol, propanol, butanol, and 2-ethylhexanol; polyhydric alcohols such as glycerin, a polyglycerol (diglycerin or the like), pentaerythritol, ethylene glycol, diethylene glycol, propylene glycol, butylene glycol, trimethylolpropane, trimethylol ethane, and a sugar alcohol; or the like.

Examples of the commercially available product of the epoxidized fatty acid ester include ADK Cizer D-32, D-55, O-130P, and O-180A (manufactured by ADEKA), and Sanso Cizer E-PS, nE-PS, E-PO, E-4030, E-6000, E-2000H, and E-9000H (manufactured by New Japan Chemical Co., Ltd.).

The polyether ester compound may be either a polyester unit or a polyether unit, each of which is aromatic or aliphatic (including alicyclic). The mass ratio of the polyester unit to the polyether unit is, for example, 20:80 to 80:20. The polyether ester compound preferably has a molecular weight (weight average molecular weight) of 250 to 2000, more preferably 280 to 1500, and still more preferably 300 to 1000. Examples of the commercially available product of the polyether ester compound include ADK Cizer RS-1000 (ADEKA).

Examples of the polyether compound having at least one unsaturated bonds in the molecule include a polyether compound having an allyl group at the end, and a polyalkylene glycol allyl ether is preferred. The polyether compound having at least one unsaturated bonds in the molecule has a molecular weight (weight average molecular weight) of 250 to 2000, more preferably 280 to 1500, and still more preferably 300 to 1000. Examples of the commercially available product of the polyether compound having at least one unsaturated bonds in the molecule include polyalkylene glycol allyl ethers such as UNIOX PKA-5006, UNIOX PKA-5008, UNIOL PKA-5014, and UNIOL PKA-5017 (NOF CORPORATION).

### [Content or Content Ratio of Components (A) to (D)]

The resin composition according to the exemplary embodiment may contain the component (A), the component (B), and the component (C), and if necessary, contain the component (D). In the resin composition according to the exemplary embodiment, the content or the content ratio (all based on mass) of each component is preferably in the following range from the viewpoint of suppressing adhesion of dust to the resin molded article.

The abbreviation of each component is as follows.

Component (A)=cellulose acylate (A)

Component (B)=thermoplastic elastomer (B)

Component (C)=metal oxide particles (C)

Component (D)=plasticizer (D)

The content of the component (A) in the resin composition according to the exemplary embodiment is preferably 50 mass % or more, more preferably 60 mass % or more, and still more preferably 70 mass % or more, based on the total mass of the resin composition.

The content of the component (B) in the resin composition according to the exemplary embodiment may be 1 mass % to 25 mass %, is preferably 1 mass % to 20 mass %, more preferably 3 mass % to 15 mass %, and still more preferably 5 mass % to 10 mass %, based on the total mass of the resin composition.

The content of the component (C) in the resin composition according to the exemplary embodiment is preferably 0.1 mass % to 2.5 mass %, more preferably 0.1 mass % to 2.0 mass %, and still more preferably 0.1 mass % to 1.5 mass %, based on the total of the resin composition.

The content of the component (D) in the resin composition according to the exemplary embodiment is preferably 0 mass % to 25 mass %, more preferably 3 mass % to 20 mass %, and still more preferably 5 mass % to 15 mass %, based on the total mass of the resin composition.

The content ratio of the component (B) to the component (A) is preferably 0.025≤(B)/(A)≤0.3, more preferably 0.03≤(B)/(A)≤0.2, and still more preferably 0.05≤(B)/(A)≤0.1.

The content ratio of the component (C) to the component (A) is preferably 0.001≤(C)/(A)≤0.05, more preferably 0.002≤(C)/(A)≤0.04, and still more preferably 0.003≤(C)/(A)≤0.03.

The content ratio of the component (D) to the component (A) is preferably 0≤(D)/(A)≤0.4, more preferably 0.02≤(D)/(A)≤0.3, and still more preferably 0.05≤(D)/(A)≤0.15.

### [Other Component (E)]

The resin composition according to the exemplary embodiment may contain other component (E) (Component (E)). In the case of containing the other component (E), the total content of other component (E) as a whole may be 15 mass % or less, based on the total amount of the resin composition. The total content of other component (E) is preferably 10 mass % or less.

Examples of other component (E) include: a flame retardant, a compatibilizer, an oxidation inhibitor, a stabilizer, a releasing agent, a light fastness agent, a weathering agent, a colorant, a pigment, a modifier, a drip inhibitor, an antistatic agent, a hydrolysis inhibitor, a filler, a reinforcing agent (such as glass fiber, carbon fiber, talc, clay, mica, glass flake, milled glass, glass beads, crystalline silica, alumina, silicon nitride, aluminum nitride, and boron nitride), an acid acceptor for preventing acetic acid from releasing (oxides such as magnesium oxide and aluminum oxide; metal hydroxides such as magnesium hydroxide, calcium hydroxide, aluminum hydroxide and hydrotalcite; calcium carbonate; talc; or the like), a reactive trapping agent (such as an epoxy compound, an acid anhydride compound, and carbodiimide), or the like.

The content of other components is preferably 0 mass % to 5 mass % based on the total amount of the resin composition. Here, “0 mass %” means not containing other components.

The resin composition according to the exemplary embodiment may contain other resins as other component (E) in addition to the component (A), the component (B), the component (C) and the component (D). However, in the case of containing other resins, the content of other resins based on the total amount of the resin composition is preferably 5 mass % or less, and preferably less than 1 mass %. The other resin may not be contained (that is, 0 mass %).

Examples of other resins include thermoplastic resins known in the related art, and specifically include: a polycarbonate resin; a polypropylene resin; a polyester resin; a polyolefin resin; a polyester carbonate resin; a polyphenylene ether resin; a polyphenylene sulfide resin; a polysulfone resin; a polyether sulfone resin; a polyarylene resin; a polyether imide resin; a polyacetal resin; a polyvinyl acetal resin; a polyketone resin; a polyether ketone resin; a polyether ether ketone resin; a polyaryl ketone resin; a polyether nitrile resin; a liquid crystal resin; a polybenzimidazole resin; a polyparabanic acid resin; a vinyl polymer or copolymer obtained by polymerizing or copolymerizing one or more vinyl monomers selected from the group consisting of an aromatic alkenyl compound, a methacrylic acid ester, an acrylic acid ester, and a vinyl cyanide compound; a diene-aromatic alkenyl compound copolymer; a vinyl cyanide-diene-aromatic alkenyl compound copolymer; an aromatic alkenyl compound-diene-vinyl cyanide-N-phenyl maleimide copolymer; a vinyl cyanide-(ethylene-diene-propylene (EPDM))-aromatic alkenyl compound copolymer; a vinyl chloride resin; a chlorinated vinyl chloride resin; or the like. The above resin may be used alone, or may be used in combination of two or more thereof.

The polyester as other component (E) may contain an aliphatic polyester (e1). Examples of the aliphatic polyester (e1) include a polymer of hydroxyalkanoate (hydroxyalkanoic acid), a polycondensate of a polycarboxylic acid and a polyhydric alcohol, a ring-opening polycondensate of a cyclic lactam, a polymer in which a lactic acid is polymerized by an ester bond, or the like.

Also, examples of other component (E) include an ester compound (e2) other than the ester compound as the aforementioned plasticizer.

The ester compound (e2) other than the ester compound as the plasticizer (D) is at least one selected from the group consisting of a compound represented by the following General Formula (1), a compound represented by the following General Formula (2), a compound represented by the following General Formula (3), a compound represented by the following General Formula (4), and a compound represented by the following General Formula (5).

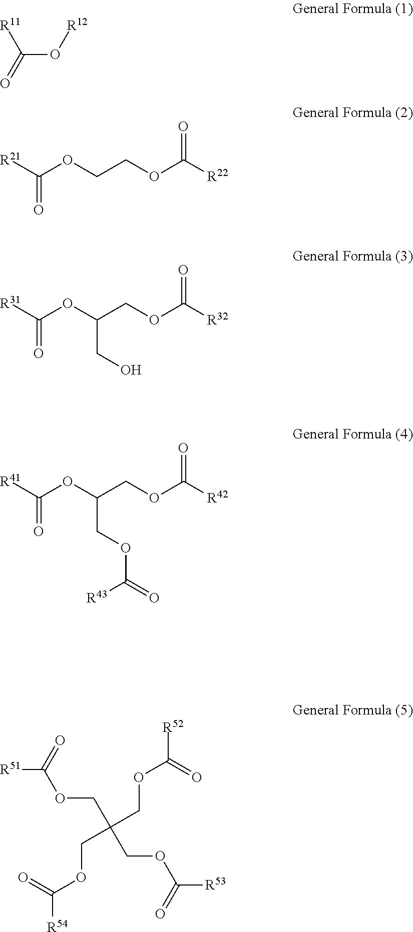

In the General Formula (1), R¹¹ represents an aliphatic hydrocarbon group having 7 to 28 carbon atoms.

In the General Formula (1), R¹² represents an aliphatic hydrocarbon group having 9 to 28 carbon atoms.

In the General Formula (2), R²¹ and R²² each independently represent an aliphatic hydrocarbon group having 7 to 28 carbon atoms.

In the General Formula (3), R³¹ and R³² each independently represent an aliphatic hydrocarbon group having 7 to 28 carbon atoms.

In the General Formula (4), R⁴¹, R⁴², and R⁴³ each independently represent an aliphatic hydrocarbon group having 7 to 28 carbon atoms.

In the General Formula (5), R⁵¹, R⁵², R⁵³, and R⁵⁴ each independently represent an aliphatic hydrocarbon group having 7 to 28 carbon atoms.

R¹¹ represents an aliphatic hydrocarbon group having 7 to 28 carbon atoms. The group represented by R¹¹ is preferably an aliphatic hydrocarbon group having 9 or more carbon atoms, more preferably an aliphatic hydrocarbon group having 10 or more carbon atoms, and still more preferably an aliphatic hydrocarbon group having 15 or more carbon atoms, from the viewpoint that the group easily acts as a lubricant with respect to the molecular chain of the resin (in particular, cellulose acylate (A), the same applies hereinafter). The group represented by R¹¹ is preferably an aliphatic hydrocarbon group having 24 or less carbon atoms, more preferably an aliphatic hydrocarbon group having 20 or less carbon atoms, and still more preferably an aliphatic hydrocarbon group having 18 or less carbon atoms, from the viewpoint that the group easily enters between the molecular chains of the resin (in particular, cellulose acylate (A), the same applies hereinafter). The group represented by R¹¹ is particularly preferably an aliphatic hydrocarbon group having 17 carbon atoms.

The group represented by R¹¹ may be a saturated aliphatic hydrocarbon group or an unsaturated aliphatic hydrocarbon group. The group represented by R¹¹ is preferably a saturated aliphatic hydrocarbon group from the viewpoint that the group easily enters between the molecular chains of the resin.

The group represented by R¹¹ may be a linear aliphatic hydrocarbon group, a branched aliphatic hydrocarbon group, or an aliphatic hydrocarbon group containing an alicyclic ring. The group represented by R¹¹ is preferably an aliphatic hydrocarbon group not containing an alicyclic ring (i.e., a chain aliphatic hydrocarbon group), and more preferably a linear aliphatic hydrocarbon group, from the viewpoint that the group easily enters between the molecular chains of the resin (A).

When the group represented by R¹¹ is an unsaturated aliphatic hydrocarbon group, the number of unsaturated bonds in the group is preferably 1 to 3, more preferably 1 or 2, and still more preferably 1, from the viewpoint that the group easily enters between the molecular chains of the resin.

When the group represented by R¹¹ is a saturated aliphatic hydrocarbon group, the main chain of the group is preferably a linear saturated hydrocarbon chain having 5 to 24 carbon atoms, more preferably a linear saturated hydrocarbon chain having 7 to 22 carbon atoms, still more preferably a linear saturated hydrocarbon chain having 9 to 20 carbon atoms, and particularly preferably a linear saturated hydrocarbon chain having 15 to 18 carbon atoms, from the viewpoint that the group easily enters between the molecular chains of the cellulose acylate (A) and easily acts as a lubricant with respect to the molecular chain of the cellulose acylate (A).

When the group represented by R¹¹ is a branched aliphatic hydrocarbon group, the number of branched chains in the group is preferably 1 to 3, more preferably 1 or 2, and still more preferably 1, from the viewpoint that the group easily enters between the molecular chains of the resin.

When the group represented by R¹¹ is a branched aliphatic hydrocarbon group, the main chain of the group preferably has 5 to 24 carbon atoms, more preferably 7 to 22 carbon atoms, still more preferably 9 to 20 carbon atoms, and particularly preferably 15 to 18 carbon atoms, from the viewpoint that the group easily enters between the molecular chains of the cellulose acylate (A) and easily acts as a lubricant with respect to the molecular chain of the cellulose acylate (A).

When the group represented by R¹¹ is an aliphatic hydrocarbon group containing an alicyclic ring, the number of alicyclic rings in the group is preferably 1 or 2, and more preferably 1, from the viewpoint that the group easily enters between the molecular chains of the resin.

When the group represented by R¹¹ is an aliphatic hydrocarbon group containing an alicyclic ring, the alicyclic ring in the group is preferably an alicyclic ring having 3 or 4 carbon atoms, and more preferably an alicyclic ring having 3 carbon atoms, from the viewpoint that the group easily enters between the molecular chains of the resin.

The group represented by R¹¹ is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and particularly preferably a linear saturated aliphatic hydrocarbon group, from the viewpoint of suppressing adhesion of dust to the resin molded article. The preferred number of carbon atoms in these aliphatic hydrocarbon groups is as described above.

The group represented by R¹¹ may be a group in which a hydrogen atom in the aliphatic hydrocarbon group is substituted with a halogen atom (e.g., a fluorine atom, a bromine atom and an iodine atom), an oxygen atom, a nitrogen atom or the like, and is preferably unsubstituted.

R¹² represents an aliphatic hydrocarbon group having 9 to 28 carbon atoms. Examples of the group represented by R¹² include the same forms as those described for R¹¹. However, the number of carbon atoms of the group represented by R¹² is preferably or less.

The group represented by R¹² is preferably an aliphatic hydrocarbon group having 10 or more carbon atoms, more preferably an aliphatic hydrocarbon group having 11 or more carbon atoms, and still more preferably an aliphatic hydrocarbon group having 16 or more carbon atoms, from the viewpoint that the group easily acts as a lubricant with respect to the molecular chain of the cellulose acylate (A). The group represented by R¹² is preferably an aliphatic hydrocarbon group having 24 or less carbon atoms, more preferably an aliphatic hydrocarbon group having 20 or less carbon atoms, and still more preferably an aliphatic hydrocarbon group having 18 or less carbon atoms, from the viewpoint that the group easily enters between the molecular chains of the resin. The group represented by R¹² is particularly preferably an aliphatic hydrocarbon group having 18 carbon atoms.

The group represented by R¹² is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and particularly preferably a linear saturated aliphatic hydrocarbon group, from the viewpoint of suppressing adhesion of dust to the resin molded article. The preferred number of carbon atoms in these aliphatic hydrocarbon groups is as described above.

The specific forms and preferred forms of the groups represented by R²¹, R²², R³¹, R³², R⁴¹, R⁴², R⁴³, R⁵¹, R⁵², R⁵³ and R⁵⁴ are the same as those described for R¹¹.

Hereinafter, specific examples of the aliphatic hydrocarbon group having 7 to 28 carbon atoms represented by R¹¹, R²¹, R²², R³¹, R³², R⁴¹, R⁴², R⁴³, R⁵¹, R⁵², R⁵³ and R⁵⁴ and specific examples of the aliphatic hydrocarbon group having 9 to 28 carbon atoms represented by R¹² are shown, but the exemplary embodiment is not limited thereto.

R¹¹, R¹², R²¹, R²², R³¹, R³², R⁴¹, R⁴², R⁴³, R⁵¹, R⁵², R⁵³, R⁵⁴
Linear and saturated

| | | |
|---|---|---|
| —C₆H₁₂CH₃ | —C₁₂H₂₄CH₃ | —C₁₉H₃₈CH₃ |
| —C₇H₁₄CH₃ | —C₁₄H₂₈CH₃ | —C₂₀H₄₀CH₃ |
| —C₈H₁₆CH₃ | —C₁₅H₃₀CH₃ | —C₂₁H₄₂CH₃ |
| —C₉H₁₈CH₃ | —C₁₆H₃₂CH₃ | —C₂₃H₄₆CH₃ |
| —C₁₀H₂₀CH₃ | —C₁₇H₃₄CH₃ | —C₂₅H₅₀CH₃ |
| —C₁₁H₂₂CH₃ | —C₁₈H₃₆CH₃ | —C₂₇H₅₄CH₃ |

R¹¹, R¹², R²¹, R²², R³¹, R³², R⁴¹, R⁴², R⁴³, R⁵¹, R⁵², R⁵³, R⁵⁴
Linear and unsaturated

| | |
|---|---|
| —CH═CH—C₄H₈CH₃ | —C₂H₄—CH═CH—C₂H₄CH₃ |
| —CH═CH—C₆H₁₂CH₃ | —C₄H₈—CH═CH—C₄H₈CH₃ |
| —CH═CH—C₈H₁₆CH₃ | —C₅H₁₀—CH═CH—C₅H₁₀CH₃ |
| —CH═CH—C₁₄H₂₈CH₃ | —C₆H₁₂—CH═CH—C₆H₁₂CH₃ |
| —CH═CH—C₁₅H₃₀CH₃ | —C₇H₁₄—CH═CH—C₃H₆CH₃ |
| —CH═CH—C₁₆H₃₂CH₃ | —C₇H₁₄—CH═CH—C₅H₁₀CH₃ |
| —CH═CH—C₁₇H₃₄CH₃ | —C₇H₁₄—CH═CH—C₇H₁₄CH₃ |
| —CH═CH—C₁₈H₃₆CH₃ | —C₇H₁₄—CH═CH—C₈H₁₆CH₃ |
| —CH═CH—C₂₀H₄₀CH₃ | —C₇H₁₄—CH═CH—C₉H₁₈CH₃ |
| —CH═CH—C₂₅H₅₀CH₃ | —C₈H₁₆—CH═CH—C₈H₁₆CH₃ |
| —C₅H₁₀—CH═CH₂ | —C₉H₁₈—CH═CH—C₅H₁₀CH₃ |
| —C₇H₁₄—CH═CH₂ | —C₉H₁₈—CH═CH—C₇H₁₄CH₃ |
| —C₁₅H₃₀—CH═CH₂ | —C₁₀H₂₀—CH═CH—C₁₂H₂₄CH₃ |
| —C₁₆H₃₂—CH═CH₂ | —C₁₀H₂₀—CH═CH—C₁₅H₃₀CH₃ |
| —C₁₇H₃₄—CH═CH₂ | —C₁₁H₂₂—CH═CH—C₇H₁₄CH₃ |
| —C₁₈H₃₆—CH═CH₂ | —C₁₂H₂₄—CH═CH—C₁₂H₂₄CH₃ |
| —C₂₁H₄₂—CH═CH₂ | —C₁₃H₂₆—CH═CH—C₇H₁₄CH₃ |
| —C₂₆H₅₂—CH═CH₂ | —CH₂—CH═CH—C₇H₁₄—CH═CH—C₇H₁₄CH₃ |
| —CH₂—CH═CH—C₃H₆CH₃ | —C₇H₁₄—CH═CH—CH₂—CH═CH—C₄H₈CH₃ |
| —CH₂—CH═CH—C₇H₁₄CH₃ | —C₇H₁₄—CH═CH—C₇H₁₄—CH═CH—C₇H₁₄CH₃ |
| —CH₂—CH═CH—C₁₀H₂₀CH₃ | —C₇H₁₄—CH═CH—C₉H₁₈—CH═CH—C₇H₁₄CH₃ |
| —CH₂—CH═CH—C₁₆H₃₂CH₃ | —C₇H₁₄—CH═CH—CH₂—CH═CH—CH₂—CH═CH—CH₂CH₃ |
| —CH₂—CH═CH—C₂₄H₄₈CH₃ | —CH═CH—C₇H₁₄—CH═CH—C₇H₁₄—CH═CH—C₇H₁₄CH₃ |

R¹¹, R¹², R²¹, R²², R³¹, R³², R⁴¹, R⁴², R⁴³, R⁵¹, R⁵², R⁵³, R⁵⁴
Branched and saturated

| | |
|---|---|
| —C₅H₁₀—CH(CH₃)₂ | —CH(C₂H₅)—C₇H₁₄CH₃ |
| —C₁₀H₂₀—CH(CH₃)₂ | —CH(C₂H₅)—C₁₄H₂₈CH₃ |
| —C₁₄H₂₈—CH(CH₃)₂ | —CH(C₂H₅)—C₁₆H₃₂CH₃ |
| —C₁₅H₃₀—CH(CH₃)₂ | —CH(C₂H₅)—C₁₈H₃₆CH₃ |
| —C₁₆H₃₂—CH(CH₃)₂ | —CH(C₄H₉)—C₁₅H₃₀CH₃ |
| —C₁₇H₃₄—CH(CH₃)₂ | —CH(C₆H₁₃)—C₁₂H₂₄CH₃ |
| —C₂₀H₄₀—CH(CH₃)₂ | —CH(C₆H₁₃)—C₁₄H₂₈CH₃ |
| —C₂₅H₅₀—CH(CH₃)₂ | —CH(C₆H₁₃)—C₁₆H₃₂CH₃ |
| —C₆H₁₂—C(CH₃)₃ | —CH₂—CH(CH₃)—C₃H₆CH₃ |
| —C₁₀H₂₀—C(CH₃)₃ | —CH₂—CH(CH₃)—C₆H₁₂CH₃ |
| —C₁₄H₂₈—C(CH₃)₃ | —CH₂—CH(CH₃)—C₈H₁₆CH₃ |
| —C₁₅H₃₀—C(CH₃)₃ | —CH₂—CH(CH₃)—C₁₂H₂₄CH₃ |
| —C₁₆H₃₂—C(CH₃)₃ | —CH₂—CH(CH₃)—C₁₆H₃₂CH₃ |
| —CH(CH₃)—C₅H₁₀CH₃ | —CH₂—CH(CH₃)—C₂₀H₄₀CH₃ |
| —CH(CH₃)—C₁₀H₂₀CH₃ | —CH₂—CH(CH₃)—C₂₄H₄₈CH₃ |
| —CH(CH₃)—C₁₃H₂₆CH₃ | —CH₂—CH(C₆H₁₃)₂ |
| —CH(CH₃)—C₁₄H₂₈CH₃ | —CH₂—CH(C₆H₁₃)—C₇H₁₄CH₃ |
| —CH(CH₃)—C₁₅H₃₀CH₃ | —CH₂—CH(C₆H₁₃)—C₉H₁₈CH₃ |
| —CH(CH₃)—C₁₆H₃₂CH₃ | —CH₂—CH(C₆H₁₃)—C₁₂H₂₄CH₃ |
| —CH(CH₃)—C₁₇H₃₄CH₃ | —CH₂—CH(C₆H₁₃)—C₁₅H₃₀CH₃ |
| —CH(CH₃)—C₁₈H₃₆CH₃ | —CH₂—CH(C₈H₁₇)—C₁₉H₃₈CH₃ |
| —CH(CH₃)—C₂₂H₄₄CH₃ | —CH₂—CH(C₈H₁₇)—C₉H₁₈CH₃ |
| —CH(CH₃)—C₂₅H₅₀CH₃ | —CH₂—CH(C₁₀H₂₁)—C₁₂H₂₄CH₃ |

—C₂H₄—CH(CH₃)—C₃H₆—CH(CH₃)—C₃H₆—CH(CH₃)—C₃H₆—CH(CH₃)₂

R¹¹, R¹², R²¹, R²², R³¹, R³², R⁴¹, R⁴², R⁴³, R⁵¹, R⁵², R⁵³, R⁵⁴
Branched and unsaturated

| | |
|---|---|
| —CH═CH—C₅H₁₀—CH(CH₃)₂ | —CH₂—CH═CH—CH(CH₃)—CH₂CH₃ |
| —CH═CH—C₁₂H₂₄—CH(CH₃)₂ | —CH₂—CH═CH—CH(CH₃)—C₃H₆CH₃ |
| —CH═CH—C₁₅H₃₀—CH(CH₃)₂ | —CH₂—CH═CH—CH(CH₃)—C₇H₁₄CH₃ |
| —CH═CH—C₁₆H₃₂—CH(CH₃)₂ | —CH₂—CH═CH—CH(CH₃)—C₁₆H₃₂CH₃ |
| —CH═CH—C₁₈H₃₆—CH(CH₃)₂ | —CH₂—CH═CH—CH(CH₃)—C₂₂H₄₄CH₃ |
| —CH═CH—C₂₃H₄₆—CH(CH₃)₂ | —CH₂—CH═CH—CH₂—CH(CH₃)—CH₂CH₃ |
| —CH═CH—C₇H₁₄—C(CH₃)₃ | —CH₂—CH═CH—C₂H₄—CH(CH₃)—C₂H₄CH₃ |
| —CH═CH—C₁₂H₂₄—C(CH₃)₃ | —CH₂—CH═CH—C₂H₄—CH(CH₃)—C₄H₈CH₃ |
| —CH═CH—C₁₄H₂₈—C(CH₃)₃ | —CH₂—CH═CH—C₆H₁₂—CH(CH₃)—C₆H₁₂CH₃ |
| —CH═CH—C₁₆H₃₂—C(CH₃)₃ | —CH₂—CH═CH—C₇H₁₄—CH(CH₃)—C₇H₁₄CH₃ |
| —CH═CH—C₂₀H₄₀—C(CH₃)₃ | —CH₂—CH═CH—C₇H₁₄—CH(CH₃)—C₈H₁₆CH₃ |
| —CH═CH—CH(C₈H₁₇)₂ | —CH₂—CH═CH—CH₂—CH═CH—CH(CH₃)—C₃H₆CH₃ |
| —CH═CH—CH(C₆H₁₃)—C₇H₁₄CH₃ | —CH₂—CH═CH—CH₂—CH═CH—CH(CH₃)—C₇H₁₄CH₃ |
| —CH═CH—CH(C₆H₁₃)—C₁₁H₂₂CH₃ | —CH₂—CH═CH—CH₂—CH═CH—CH(CH₃)—C₁₆H₃₂CH₃ |
| —CH═CH—CH(C₈H₁₇)—C₉H₁₈CH₃ | —CH₂—CH═CH—CH(CH₃)—CH═CH—CH₂—C₃H₆CH₃ |
| —CH═CH—CH(C₈H₁₇)—C₁₂H₂₄CH₃ | —CH₂—CH═CH—CH(CH₃)—CH═CH—CH₂—C₇H₁₄CH₃ |
| —C₃H₆—CH═CH—C₅H₁₀—CH(CH₃)₂ | —CH₂—CH═CH—CH(C₂H₅)—CH═CH—CH₂—C₇H₁₄CH₃ |
| —C₇H₁₄—CH═CH—C₆H₁₂—CH(CH₃)₂ | —CH₂—CH═CH—CH(CH₃)—CH═CH—CH₂—C₁₆H₃₂CH₃ |
| —C₇H₁₄—CH═CH—C₇H₁₄—CH(CH₃)₂ | —CH₂—CH═CH—CH(C₂H₅)—CH═CH—CH₂—C₁₆H₃₂CH₃ |
| —C₈H₁₆—CH═CH—C₆H₁₂—CH(CH₃)₂ | —CH₂—CH═CH—CH(CH₃)—CH═CH—CH₂—C₁₉H₃₈CH₃ |
| —C₈H₁₆—CH═CH—C₇H₁₄—CH(CH₃)₂ | —CH₂—CH═CH—CH(CH₃)—CH═CH—CH(CH₃)—CH₂CH₃ |
| —CH(CH₃)—C₁₄H₂₈—CH═CH₂ | —CH₂—CH═CH—CH(CH₃)—CH═CH—CH(CH₃)—C₃H₆CH₃ |
| —CH(CH₃)—C₁₆H₃₂—CH═CH₂ | —CH₂—CH═CH—CH(CH₃)—CH═CH—CH(CH₃)—C₇H₁₄CH₃ |
| —CH(C₂H₅)—C₁₄H₂₈—CH═CH₂ | —CH₂—CH═CH—CH(C₂H₅)—CH═CH—CH(C₂H₅)—C₇H₁₄CH₃ |
| —CH(C₂H₅)—C₁₆H₃₂—CH═CH₂ | —CH₂—CH═CH—CH(CH₃)—CH═CH—CH(CH₃)—C₁₂H₂₄CH₃ |
| —CH(C₄H₉)—C₁₄H₂₈—CH═CH₂ | —CH₂—CH═CH—CH(CH₃)—CH═CH—CH(CH₃)—C₁₅H₃₀CH₃ |
| —CH(C₆H₁₃)—C₁₀H₂₀—CH═CH₂ | —CH₂—CH═CH—CH(CH₃)—CH═CH—CH(CH₃)—C₁₈H₃₆CH₃ |
| —CH(C₆H₁₃)—C₁₂H₂₄—CH═CH₂ | —C₄H₈—CH═CH—C₄H₈—CH═CH—C₄H₈—CH(CH₃)₂ |
| —CH₂—CH(C₆H₁₃)—C₇H₁₄—CH═CH₂ | —C₇H₁₄—CH═CH—C₇H₁₄—CH═CH—C₇H₁₄—CH(CH₃)₂ |

The ester compound (e2) other than the ester compound as the plasticizer (D) may be used alone, or may be used in combination of two or more thereof.

Further, it is also preferable that the resin composition according to the exemplary embodiment contains an oxidation inhibitor or a stabilizer as other component (E). At least one compound (e3) selected from the group consisting of a hindered phenol compound, a tocopherol compound, a tocotrienol compound, a phosphite compound and a hydroxylamine compound is preferably contained as the oxidation inhibitor or the stabilizer.

Specific examples of the compound (e3) include hindered phenol compounds such as “Irganox 1010”, “Irganox 245”, and “Irganox 1076” manufactured by BASF, “ADK STAB AO-80”, “ADK STAB AO-60”, “ADK STAB AO-50”, “ADK STAB AO-40”, “ADK STAB AO-30”, “ADK STAB AO-20”, and “ADK STAB AO-330” manufactured by ADEKA Corporation, “Sumilizer GA-80” manufactured by Sumitomo Chemical Co., Ltd., and “Sumilizer GM” and “Sumilizer GS” manufactured by Sumitomo Chemical Co., Ltd.; phosphite compounds such as “Irgafos 38” (bis(2,4-di-t-butyl-6-methylphenyl)-ethyl-phosphite) manufactured by BASF, “Irgafos 168” manufactured by BASF, “Irgafos TNPP” manufactured by BASF, “Irgafos P-EPQ” manufactured by BASF; hydroxylamine compounds such as “Irgastab FS-042” manufactured by BASF; or the like.

Further, specific examples of the tocopherol compound in the compound (e3) include, for example, the following compounds.

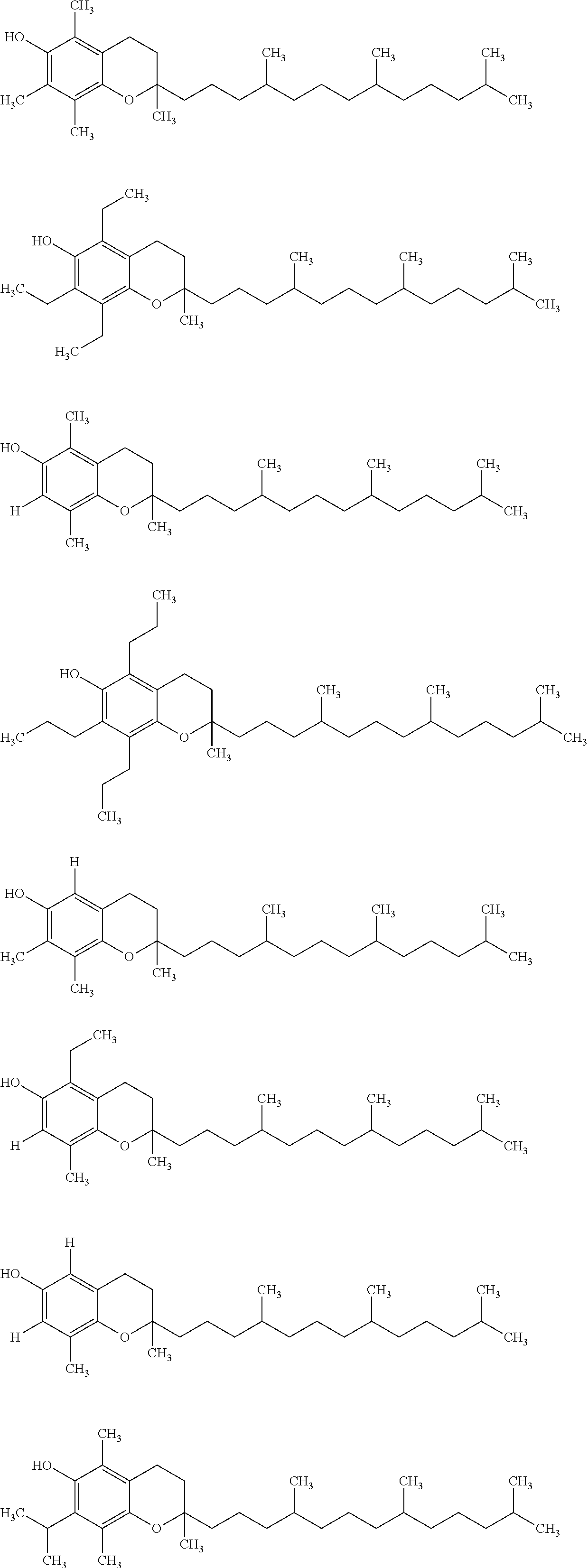

Specific examples of the tocotrienol compound in the compound (e3) include, for example, the following compounds.

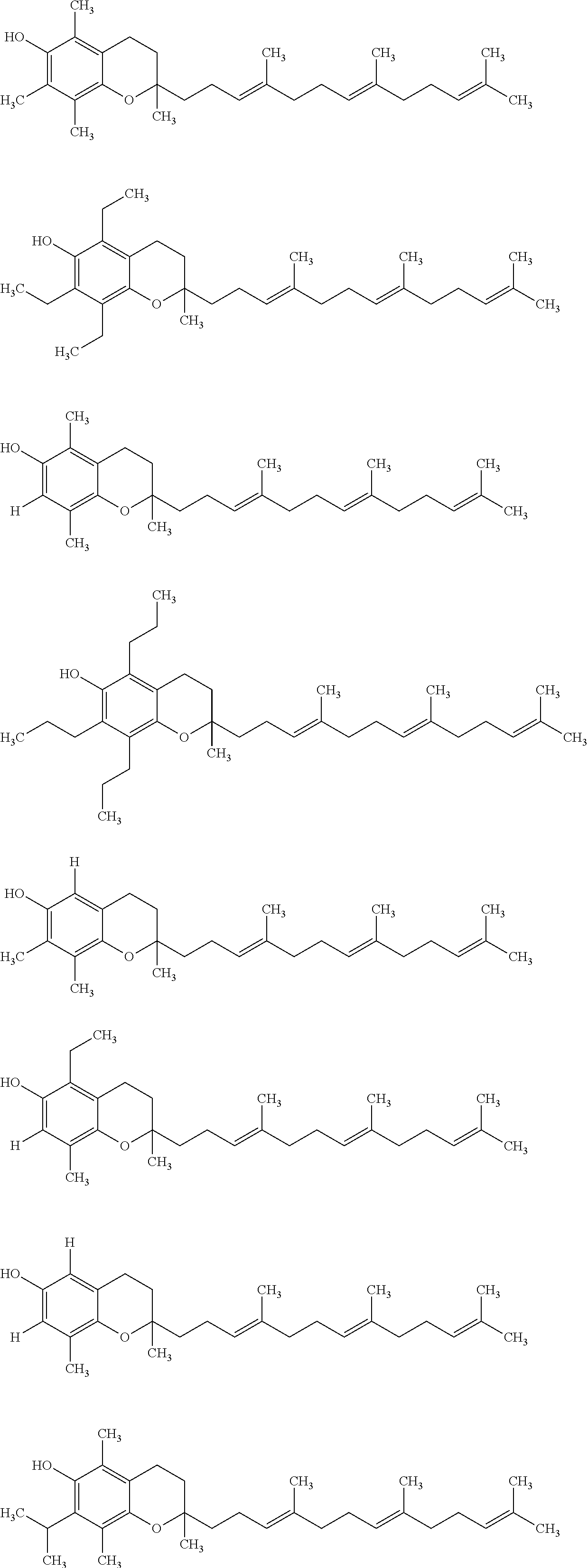

### [Method for Producing Resin Composition]

Examples of the method for producing the resin composition according to the exemplary embodiment include: a method for mixing and melt-kneading the component (A), the component (B), and the component (C) and if necessary, the component (D) and other component (E); a method for dissolving the component (A), the component (B) and the component (C), and, if necessary, the component (D) and other component (E) in a solvent; or the like. Here, the melt-kneading means is not particularly limited, and examples thereof include a twin-screw extruder, a Henschel mixer, a Banbury mixer, a single screw extruder, a multi-screw extruder, a co-kneader or the like.

### <Resin Molded Article>

The resin molded article according to the exemplary embodiment contains the resin composition according to the exemplary embodiment. That is, the resin molded article according to the exemplary embodiment has the same composition as the resin composition according to the exemplary embodiment.

The method for forming the resin molded article according to the exemplary embodiment is preferably injection molding from the viewpoint of obtaining a high degree of freedom of shape. Therefore, the resin molded article according to the exemplary embodiment is preferably an injection molded article obtained by injection molding, from the viewpoint of obtaining a high degree of freedom of shape.

The cylinder temperature during the injection molding of the resin molded article according to the exemplary embodiment is, for example, 160° C. to 280° C., and preferably 180° C. to 240° C. The mold temperature during the injection molding of the resin molded article according to the exemplary embodiment is, for example, 40° C. to 90° C., and more preferably 40° C. to 60° C.

The injection molding of the resin molded article according to the exemplary embodiment is performed, for example, by using commercial devices such as NEX 500 manufactured by NISSEI PLASTIC INDUSTRIAL CO., LTD., NEX 150 manufactured by NISSEI PLASTIC INDUSTRIAL CO., LTD., NEX 7000 manufactured by NISSEI PLASTIC INDUSTRIAL CO., LTD., PNX 40 manufactured by NISSEI PLASTIC INDUSTRIAL CO., LTD., and SE50D manufactured by Sumitomo Heavy Industries, Ltd.

The molding method for obtaining the resin molded article according to the exemplary embodiment is not limited to the above injection molding, and injection molding, extrusion molding, blow molding, hot press molding, calender molding, coating molding, cast molding, dipping molding, vacuum molding, transfer molding or the like may also be applied.

The resin molded article according to the exemplary embodiment is suitably used for applications such as electronic and electrical equipment, office equipment, household electric appliances, automotive interior materials, toys, containers, or the like. Specific applications of the resin molded article according to the exemplary embodiment include: casings of electronic/electric devices or household electric appliances; various parts of electronic/electric devices or home electric appliances; interior parts of automobiles; block assembled toys; plastic model kits; CD-ROM or DVD storage cases; dishware; beverage bottles; food trays; wrapping materials; films; sheets; or the like.

### EXAMPLES

Hereinafter, the resin composition and the resin molded article according to the exemplary embodiment will be described in more detail by means of examples. Materials, amounts, ratios, processing procedures, or the like shown in the following examples may be appropriately changed without departing from the gist of the exemplary embodiment. Therefore, the resin composition and the resin molded article according to the exemplary embodiment should not be interpreted restrictively by the following specific examples.

### <Preparation of Each Material>

The following materials are prepared.

### [Cellulose Acylate (A)]

CA1: Eastman Chemical “CAP 482-20”, having a cellulose acetate propionate weight-average polymerization degree of 716, an acetyl group degree of substitution of 0.18 and a propionyl group degree of substitution of 2.49.

CA2: Eastman Chemical “CAP 482-0.5”, cellulose acetate propionate, having a weight-average polymerization degree of 189, an acetyl group degree of substitution of 0.18 and a propionyl group degree of substitution of 2.49.

CA3: Eastman Chemical “CAP 504-0.2”, cellulose acetate propionate, having a weight-average polymerization degree of 133, an acetyl group degree of substitution of 0.04 and a propionyl group degree of substitution of 2.09.

CA4: Eastman Chemical “CAB 171-15”, cellulose acetate butyrate, having a weight-average polymerization degree of 754, an acetyl group degree of substitution of 2.07 and a butyryl group degree of substitution of 0.73.

CA5: Eastman Chemical “CAB 381-20”, cellulose acetate butyrate, having a weight-average polymerization degree of 890, an acetyl group degree of substitution of 1.05 and a butyryl group degree of substitution of 1.74.

CA6: Eastman Chemical “CAB 500-5”, cellulose acetate butyrate, having a weight-average polymerization degree of 625, an acetyl group degree of substitution of 0.17 and a butyryl group degree of substitution of 2.64.

CA7: Daicel “L50”, diacetyl cellulose, having a weight-average polymerization degree of 570.

CA8: Daicel “LT-35”, triacetyl cellulose, having a weight-average polymerization degree of 385.

RC1: Eastman Chemical “Tenite propionate 360A4000012”, cellulose acetate propionate, having a weight-average polymerization degree of 716, an acetyl group degree of substitution of 0.18 and a propionyl group degree of substitution of 2.49. The product contained dioctyl adipate corresponding to component (D), and the content of cellulose acetate propionate is 88 mass % and the amount of dioctyl adipate is 12 mass %.

RC2: Eastman Chemical “Treva GC6021”, cellulose acetate propionate, having a weight-average polymerization degree of 716, an acetyl group degree of substitution of 0.18 and a propionyl group degree of substitution of 2.49. The product contains 3 mass % to 10 mass % of a chemical substance corresponding to the component (B).

CA1 satisfied the following (2), (3) and (4). CA2 satisfied the following (4).

(2) When measured by the GPC method using tetrahydrofuran as a solvent, the weight average molecular weight (Mw) in terms of polystyrene is 160,000 to 250,000, a ratio Mn/Mz of a number average molecular weight (Mn) in terms of polystyrene to a Z average molecular weight (Mz) in terms of polystyrene is 0.14 to 0.21, and a ratio Mw/Mz of a weight average molecular weight (Mw) in terms of polystyrene to the Z average molecular weight (Mz) in terms of polystyrene is 0.3 to 0.7.
(3) When measured with a capillography at a condition of 230° C. according to ISO 11443:1995, a ratio η1/η2 of a viscosity η1 (Pa·s) at a shear rate of 1216 (/sec) to a viscosity η2 (Pa·s) at a shear rate of 121.6 (/sec) is 0.1 to 0.3.
(4) When a small square plate test piece (D11 test piece specified by JIS K7139:2009, 60 mm×60 mm, thickness 1 mm) obtained by injection molding of the CAP is allowed to stand in an atmosphere at a temperature of 65° C. and a relative humidity of 85% for 48 hours, both an expansion coefficient in an MD direction and an expansion coefficient in a TD direction are 0.4% to 0.6%.

### [Thermoplastic Elastomer (B)]

EL1: Mitsubishi Chemical “METABLEN W-600A”, core-shell structure polymer (b2), a shell layer polymer obtained by grafting and polymerizing “a methyl methacrylate homopolymer rubber” to “a copolymer rubber of 2-ethylhexyl acrylate and n-butyl acrylate” as a core layer, having an average primary particle diameter of 200 nm.

EL2: Mitsubishi Chemical “METABLEN S-2006”, core-shell structure polymer (b2), a polymer whose core layer contains a “silicone-acrylic rubber” and whose shell layer contains a “methyl methacrylate polymer”, having an average primary particle diameter of 200 nm.

EL3: Dow Chemical Japan “PARALOID EXL2315”, core-shell structure polymer (b2), a shell layer polymer obtained by grafting and polymerizing a “methyl methacrylate polymer” to a “rubber whose main component is butyl polyacrylate” as a core layer, having an average primary particle diameter of 300 nm.

EL4: Arkema “Lotryl 29 MA 03”, olefin polymer (b3), a copolymer of ethylene and methyl acrylate and an olefin polymer containing 71 mass % of monomers derived from ethylene.

EL5: “Kane Ace B-564” manufactured by Kaneka Corporation, MBS (methyl methacrylate-butadiene-styrene copolymer) based resin, core-shell structure polymer (b1).

EL6: “Blendex 338” manufactured by Galata Chemicals (Artek), ABS (acrylonitrile-butadiene-styrene copolymer) core shell, core-shell structure polymer (b1).

EL7: Kraton Corporation “Kraton FG 1924G”, styrene-ethylene-butadiene-styrene copolymer (b4).

EL8: Lubrizol “Estane ALR 72A”, polyurethane (b5).

EL9: DU PONT-TORAY “Hytrel 3078”, an aromatic polyester (b6), a polyester copolymer.

### [Metal Oxide Particles (C)]

MO 1: SAKAI CHEMICAL “SA-1”, titanium oxide (IV); average particle diameter=150 nm.

MO 2: Mitsubishi Material Electronic Chemical “S-2000”, tin oxide (IV); average particle diameter=30 nm.

MO 3: BASF “Sicotrans (registered trademark) Red K 2819”, iron oxide (III).

MO 4: BASF “Sicotan (registered trademark) Yellow K 2001 FG”, titanium nickel antimony; average particle diameter=1.62 μm (D 90).

MO 5: BASF “Sicotan (registered trademark) Yellow K 1011 FG”, chromium nickel antimony; average particle diameter=2.82 μm (D 90).

MO 6: BASF “Sicopal (registered trademark) Blue L 6210”, cobalt blue; average particle diameter=1.27 μm (D 50).

MO 7: BASF “Sicopal (registered trademark) Yellow L 1130”, bismuth vanadium oxide.

MO 8: SAKAI CHEMICAL “Class 1 Zinc Oxide”, zinc oxide; average particle diameter=600 nm.

MO 9: Furukawa Chemicals “FCO-500”, copper oxide: average particle diameter=5 μm or less.

### [Plasticizer (D)]

PL1: Cardolite “NX-2026”, cardanol, having a molecular weight of 298 to 305.

PL2: Cardolite “Ultra LITE 2020”, hydroxyethylated cardanol, having a molecular weight of 343 to 349.

PL3: Cardolite “GX-5170”, hydroxyethylated cardanol, having a molecular weight of 827 to 833.

PL4: Cardolite “Ultra LITE 513”, glycidyl ether of cardanol, having a molecular weight of 354 to 361.

PL5: Cardolite “NC-514S”, cardanol-derived bifunctional epoxy compound, having a molecular weight 534 to 537.

PL6: DAIHACHI CHEMICAL INDUSTRY “Daifatty 101”, an adipate ester-containing compound, having a molecular weight of 326 to 378.

PL7: Mitsubishi Chemical “DOA”, dioctyl adipate, having a molecular weight of 371.

PL8: Jungbunzlauer “CITROFOL AHII”, acetyl 2-ethylhexyl citrate, having a molecular weight of 571.

PL9: DAIHACHI CHEMICAL INDUSTR “DOS”, bis(2-ethylhexyl) sebacate, having a molecular weight of 427.

PL10: Mitsubishi Chemical “JP120”, glycol benzoate, having a molecular weight of 327.

PL11: Mitsubishi Chemical “DOTP”, bis(2-ethylhexyl) terephthalate, having a molecular weight of 391.

PL12: ADEKA “ADK Cizer D-32”, epoxidized fatty acid 2-ethylhexyl, having a molecular weight about of 420.

PL13: NOF “PEG #600”, polyethylene glycol, having a molecular weight of about 600.

### [Other Component (E)]

PE1: Nature Works “Ingeo 3001D”, a polylactic acid.

PM1: Asahi Kasei “DELPET 720V”, polymethyl methacrylate.

ABS 1: Daicel Polymer “Cevian V 500” acrylonitrile-styrene-butadiene copolymer.

ST1: BASF “Irganox B225”, a mixture of pentaerythritol tetrakis(3-(3,5-di-t-butyl-4-hydroxyphenyl)propionate) and tris(2,4-di-t-butylphenyl) phosphite.

LU1: FUJIFILM Wako pure chemical “stearyl stearate”, stearyl stearate. A compound represented by the General Formula (1), R¹¹ has 17 carbon atoms and R¹² has 18 carbon atoms.

PC1: DAIHACHI CHEMICAL “PX-200”, condensed phosphoric ester.

### Production of Resin Composition and Injection Molding of Resin Molded Article

### Examples 1 to 57, Comparative Examples 1 to 4

Kneading is performed with a twin-screw kneader (LTE 20-44, manufactured by Labtech Engineering) at the charged amounts and kneading temperatures shown in Tables 4 to 6 to obtain a pellet (resin composition). In addition, using the pellet, with an injection molding machine (NEX500I, manufactured by NISSEI PLASTIC INDUSTRIAL CO., LTD.), at an injection peak pressure not exceeding 180 MPa and at molding temperatures and mold temperatures shown in Tables 4 to 6, a D12 test piece (60 mm×60 mm×thickness 2 mm) is molded in accordance with the method prescribed in ISO 294-3 (2002).

### <Evaluation of Adhesion of Dust>

After placing the obtained D12 test piece in a sealed container and leaving it in an environment at 23° C. and 50% RH for 48 hours, artificial sand (FINE-Bz AZ 10 #60, manufactured by Kobe Rikagaku Kogyo Co., Ltd.) is adhered to the surface of the test piece at a pneumatic pressure of 0.3 MPa. Thereafter, the artificial sand is sifted using a vibrating fluid conveyor (manufactured by TOKYO SHISETSU-KOGYO CO., LTD., Eurel VC). Then, the surface of the D12 test piece is observed with an optical microscope (BX 51 M, manufactured by Olympus Corporation), and the adhesion of dust is evaluated according to the following standard.

### —Evaluation Standard—

G5: The artificial sand is adhered with an area which is 5% or less. G4: The artificial sand is adhered with an area which is more than 5% but less than 30%. G3: The artificial sand is adhered with an area which is 30% or more and less than 50%. G2: The artificial sand is adhered with an area which is 50% or more and less than 95%. G1: The artificial sand is adhered with an area which is 95% or more.

TABLE 1

| | Cellulose ester | | Thermoplastic | | Metal oxide | | | |
|---|---|---|---|---|---|---|---|---|
| | (A) | | elastomer (B) | | particles (C) | | Plasticizer (D) | |
| | Type | Parts by mass | Type | Parts by mass | Type | Parts by mass | Type | Parts by mass |
| Example 1 | CA1 | 91.5 | EL1 | 7.5 | M04 | 0.6 | PL1 | 8.5 |
| Example 2 | CA1 | 91.5 | EL2 | 7.5 | M04 | 0.6 | PL1 | 8.5 |
| Example 3 | CA1 | 91.5 | EL3 | 7.5 | M04 | 0.6 | PL1 | 8.5 |
| Example 4 | CA1 | 91.5 | EL4 | 7.5 | M04 | 0.6 | PL1 | 8.5 |
| Example 5 | CA1 | 91.5 | EL5 | 7.5 | M04 | 0.6 | PL1 | 8.5 |
| Example 6 | CA1 | 91.5 | EL6 | 7.5 | M04 | 0.6 | PL1 | 8.5 |
| Example 7 | CA1 | 91.5 | EL7 | 7.5 | M04 | 0.6 | PL1 | 8.5 |
| Example 8 | CA1 | 91.5 | EL8 | 7.5 | M04 | 0.6 | PL1 | 8.5 |
| Example 9 | CA1 | 91.5 | EL9 | 7.5 | M04 | 0.6 | PL1 | 8.5 |
| Example 10 | CA1 | 91.5 | EL1 | 7.5 | M04 | 0.1 | PL1 | 8.5 |
| Example 11 | CA1 | 91.5 | EL1 | 7.5 | M04 | 0.2 | PL1 | 8.5 |
| Example 12 | CA1 | 91.5 | EL1 | 7.5 | M04 | 2.5 | PL1 | 8.5 |
| Example 13 | CA1 | 91.5 | EL1 | 7.5 | M04 | 3 | PL1 | 8.5 |
| Example 14 | CA2 | 91.5 | EL1 | 7.5 | M04 | 0.6 | PL1 | 8.5 |
| Example 15 | CA3 | 91.5 | EL1 | 7.5 | M04 | 0.6 | PL1 | 8.5 |
| Example 16 | CA4 | 91.5 | EL1 | 7.5 | M04 | 0.6 | PL1 | 8.5 |
| Example 17 | CA5 | 91.5 | EL1 | 7.5 | M04 | 0.6 | PL1 | 8.5 |
| Example 18 | CA6 | 91.5 | EL1 | 7.5 | M04 | 0.6 | PL1 | 8.5 |
| Example 19 | CA7 | 85 | EL1 | 7.5 | M04 | 0.6 | PL1 | 15 |
| Example 20 | CA8 | 75 | EL1 | 7.5 | M04 | 0.6 | PL1 | 25 |

| | Other component (E) | | | | | | | | | |
|---|---|---|---|---|---|---|---|---|---|---|
| | | Parts by | | Parts by | | Parts by | | Parts by | | Parts by |
| | Type | mass | Type | mass | Type | mass | Type | mass | Type | mass |
| Example 1 | | | | | ST1 | 0.5 | | | | |
| Example 2 | | | | | ST1 | 0.5 | | | | |
| Example 3 | | | | | ST1 | 0.5 | | | | |
| Example 4 | | | | | ST1 | 0.5 | | | | |
| Example 5 | | | | | ST1 | 0.5 | | | | |
| Example 6 | | | | | ST1 | 0.5 | | | | |
| Example 7 | | | | | ST1 | 0.5 | | | | |
| Example 8 | | | | | ST1 | 0.5 | | | | |
| Example 9 | | | | | ST1 | 0.5 | | | | |
| Example 10 | | | | | ST1 | 0.5 | | | | |
| Example 11 | | | | | ST1 | 0.5 | | | | |
| Example 12 | | | | | ST1 | 0.5 | | | | |
| Example 13 | | | | | ST1 | 0.5 | | | | |
| Example 14 | | | | | ST1 | 0.5 | | | | |
| Example 15 | | | | | ST1 | 0.5 | | | | |
| Example 16 | | | | | ST1 | 0.5 | | | | |
| Example 17 | | | | | ST1 | 0.5 | | | | |
| Example 18 | | | | | ST1 | 0.5 | | | | |
| Example 19 | | | | | ST1 | 0.5 | | | | |
| Example 20 | | | | | ST1 | 0.5 | | | | |

TABLE 2

| | Cellulose ester | | Thermoplastic | | Metal oxide | | | |
|---|---|---|---|---|---|---|---|---|
| | (A) | | elastomer (B) | | particles (C) | | Plasticizer (D) | |
| | Type | Parts by mass | Type | Parts by mass | Type | Parts by mass | Type | Parts by mass |
| Example 21 | CA1 | 91.5 | EL1 | 7.5 | M01 | 0.6 | PL1 | 8.5 |
| Example 22 | CA1 | 91.5 | EL1 | 7.5 | M02 | 0.6 | PL1 | 8.5 |
| Example 23 | CA1 | 91.5 | EL1 | 7.5 | M03 | 0.6 | PL1 | 8.5 |
| Example 24 | CA1 | 91.5 | EL1 | 7.5 | M05 | 0.6 | PL1 | 8.5 |
| Example 25 | CA1 | 91.5 | EL1 | 7.5 | M06 | 0.6 | PL1 | 8.5 |
| Example 26 | CA1 | 91.5 | EL1 | 7.5 | M07 | 0.6 | PL1 | 8.5 |
| Example 27 | CA1 | 91.5 | EL1 | 7.5 | M08 | 0.6 | PL1 | 8.5 |
| Example 28 | CA1 | 91.5 | EL1 | 7.5 | M09 | 0.6 | PL1 | 8.5 |
| Example 29 | CA1 | 91.5 | EL1 | 7.5 | M04 | 0.6 | PL2 | 8.5 |
| Example 30 | CA1 | 91.5 | EL1 | 7.5 | M04 | 0.6 | PL3 | 8.5 |
| Example 31 | CA1 | 91.5 | EL1 | 7.5 | M04 | 0.6 | PL4 | 8.5 |
| Example 32 | CA1 | 91.5 | EL1 | 7.5 | M04 | 0.6 | PL5 | 8.5 |
| Example 33 | CA1 | 91.5 | EL1 | 7.5 | M04 | 0.6 | PL6 | 8.5 |
| Example 34 | CA1 | 91.5 | EL1 | 7.5 | M04 | 0.6 | PL7 | 8.5 |
| Example 35 | CA1 | 91.5 | EL1 | 7.5 | M04 | 0.6 | PL8 | 8.5 |
| Example 36 | CA1 | 91.5 | EL1 | 7.5 | M04 | 0.6 | PL9 | 8.5 |
| Example 37 | CA1 | 91.5 | EL1 | 7.5 | M04 | 0.6 | PL10 | 8.5 |
| Example 38 | CA1 | 91.5 | EL1 | 7.5 | M04 | 0.6 | PL11 | 8.5 |
| Example 39 | CA1 | 91.5 | EL1 | 7.5 | M04 | 0.6 | PL12 | 8.5 |
| Example 40 | CA1 | 91.5 | EL1 | 7.5 | M04 | 0.6 | PL13 | 8.5 |

| | Other component (E) | | | | | | | | | |
|---|---|---|---|---|---|---|---|---|---|---|
| | | Parts by | | Parts by | | Parts by | | Parts by | | Parts by |
| | Type | mass | Type | mass | Type | mass | Type | mass | Type | mass |
| Example 21 | | | | | ST1 | 0.5 | | | | |
| Example 22 | | | | | ST1 | 0.5 | | | | |
| Example 23 | | | | | ST1 | 0.5 | | | | |
| Example 24 | | | | | ST1 | 0.5 | | | | |
| Example 25 | | | | | ST1 | 0.5 | | | | |
| Example 26 | | | | | ST1 | 0.5 | | | | |
| Example 27 | | | | | ST1 | 0.5 | | | | |
| Example 28 | | | | | ST1 | 0.5 | | | | |
| Example 29 | | | | | ST1 | 0.5 | | | | |
| Example 30 | | | | | ST1 | 0.5 | | | | |
| Example 31 | | | | | ST1 | 0.5 | | | | |
| Example 32 | | | | | ST1 | 0.5 | | | | |
| Example 33 | | | | | ST1 | 0.5 | | | | |
| Example 34 | | | | | ST1 | 0.5 | | | | |
| Example 35 | | | | | ST1 | 0.5 | | | | |
| Example 36 | | | | | ST1 | 0.5 | | | | |
| Example 37 | | | | | ST1 | 0.5 | | | | |
| Example 38 | | | | | ST1 | 0.5 | | | | |
| Example 39 | | | | | ST1 | 0.5 | | | | |
| Example 40 | | | | | ST1 | 0.5 | | | | |

TABLE 3

| | Cellulose ester | | Thermoplastic | | Metal oxide | | | |
|---|---|---|---|---|---|---|---|---|
| | (A) | | elastomer (B) | | particles (C) | | Plasticizer (D) | |
| | Type | Parts by mass | Type | Parts by mass | Type | Parts by mass | Type | Parts by mass |
| Example 41 | CA1 | 91.5 | EL1 | 7.5 | M04 | 0.6 | PL1 | 8.5 |
| Example 42 | CA1 | 91.5 | EL1 | 7.5 | M04 | 0.7 | PL1 | 8.5 |
| Example 43 | RC2 | 100 | EL1 | 3 | M04 | 0.6 | PL1 | 5 |
| Example 44 | RC1 | 100 | EL1 | 5 | M04 | 0.7 | | |
| Example 45 | CA1 | 91.5 | EL1 | 7.5 | M04 | 0.6 | | |
| Example 46 | CA1 | 91.5 | EL1 | 3 | M04 | 0.6 | | |
| Example 47 | CA1 | 91.5 | EL1 | 15 | M04 | 0.6 | | |
| Example 48 | CA1 | 91.5 | EL1 | 1 | M04 | 0.6 | | |
| Example 49 | CA1 | 91.5 | EL1 | 25 | M04 | 0.6 | | |
| Example 50 | CA1 | 91.5 | EL1 | 7.5 | M04 | 0.6 | PL1 | 3 |
| Example 51 | CA1 | 91.5 | EL1 | 7.5 | M04 | 0.6 | PL1 | 15 |
| Example 52 | CA1 | 91.5 | EL1 | 7.5 | M04 | 0.6 | PL1 | 2 |
| Example 53 | CA1 | 91.5 | EL1 | 7.5 | M04 | 0.6 | PL1 | 18 |
| Example 54 | CA1 | 91.5 | EL1 | 7.5 | M04 | 0.6 | PL1 | 8.5 |
| Example 55 | CA1 | 91.5 | EL1 | 7.5 | M04 | 0.6 | PL1 | 8.5 |
| Example 56 | CA1 | 91.5 | EL1 | 7.5 | M04 | 0.6 | PL1 | 8.5 |
| Example 57 | CA1 | 91.5 | EL1 | 7.5 | M04 | 0.6 | PL1 | 8.5 |
| Comparative | CA1 | 91.5 | | | M04 | 0.6 | PL1 | 8.5 |
| Example 1 | | | | | | | | |
| Comparative | CA1 | 91.5 | EL1 | 7.5 | | | PL1 | 8.5 |
| Example 2 | | | | | | | | |
| Comparative | CA1 | 90 | | | M01 | 1.3 | | |
| Example 3 | | | | | | | | |
| Comparative | CA1 | 88 | | | M04 | 0.6 | PL7 | 12 |
| Example 4 | | | | | | | | |

| | Other component (E) | | | | | | | | | |
|---|---|---|---|---|---|---|---|---|---|---|
| | | Parts by | | Parts by | | Parts by | | Parts by | | Parts by |
| | Type | mass | Type | mass | Type | mass | Type | mass | Type | mass |
| Example 41 | | | | | ST1 | 0.5 | | | | |
| Example 42 | PE1 | 5 | PM1 | 5 | ST1 | 0.5 | LU1 | 2 | | |
| Example 43 | | | | | ST1 | 0.5 | | | | |
| Example 44 | | | PM1 | 15 | ST1 | 0.5 | | | | |
| Example 45 | | | | | | | | | | |
| Example 46 | | | | | | | | | | |
| Example 47 | | | | | | | | | | |
| Example 48 | | | | | | | | | | |
| Example 49 | | | | | | | | | | |
| Example 50 | | | | | ST1 | 0.5 | | | | |
| Example 51 | | | | | ST1 | 0.5 | | | | |
| Example 52 | | | | | ST1 | 0.5 | | | | |
| Example 53 | | | | | ST1 | 0.5 | | | | |
| Example 54 | | | | | ST1 | 0.2 | | | | |
| Example 55 | | | | | ST1 | 5 | | | | |
| Example 56 | | | | | ST1 | 0.1 | | | | |
| Example 57 | | | | | ST1 | 7 | | | | |
| Comparative | | | | | ST1 | 0.5 | | | | |
| Example 1 | | | | | | | | | | |
| Comparative | | | | | ST1 | 0.5 | LU1 | 0.5 | | |
| Example 2 | | | | | | | | | | |
| Comparative | | | ABS1 | 10 | ST1 | 0.1 | LU1 | 0.5 | PC1 | 25 |
| Example 3 | | | | | | | | | | |
| Comparative | | | | | | | | | | |
| Example 4 | | | | | | | | | | |

TABLE 4

| | | | | Mass | Dust |
|---|---|---|---|---|---|
| | Kneading | Molding | Mold | ratio of | adhe- |
| | tempera- | tempera- | tempera- | component | sion |
| | ture | ture | ture | (C) | property |
| | (° C.) | (° C.) | (° C.) | (%) | (Grade) |
| Example 1 | 200 | 200 | 40 | 0.55 | G5 |
| Example 2 | 200 | 200 | 40 | 0.55 | G5 |
| Example 3 | 200 | 200 | 40 | 0.55 | G5 |
| Example 4 | 200 | 200 | 40 | 0.55 | G5 |
| Example 5 | 200 | 200 | 40 | 0.55 | G5 |
| Example 6 | 200 | 200 | 40 | 0.55 | G5 |
| Example 7 | 200 | 200 | 40 | 0.55 | G5 |
| Example 8 | 200 | 200 | 40 | 0.55 | G5 |
| Example 9 | 200 | 200 | 40 | 0.55 | G5 |
| Example 10 | 200 | 200 | 40 | 0.09 | G5 |
| Example 11 | 200 | 200 | 40 | 0.18 | G5 |
| Example 12 | 200 | 200 | 40 | 2.26 | G5 |
| Example 13 | 200 | 200 | 40 | 2.70 | G5 |
| Example 14 | 200 | 200 | 40 | 0.55 | G5 |
| Example 15 | 200 | 200 | 40 | 0.55 | G5 |
| Example 16 | 200 | 200 | 40 | 0.55 | G5 |
| Example 17 | 200 | 200 | 40 | 0.55 | G5 |
| Example 18 | 200 | 200 | 40 | 0.55 | G5 |
| Example 19 | 220 | 220 | 40 | 0.55 | G3 |
| Example 20 | 230 | 230 | 40 | 0.55 | G3 |

TABLE 5

| | | | | Mass | Dust |
|---|---|---|---|---|---|
| | Kneading | Molding | Mold | ratio of | adhe- |
| | tempera- | tempera- | tempera- | component | sion |
| | ture | ture | ture | (C) | property |
| | (° C.) | (° C.) | (° C.) | (%) | (Grade) |
| Example 21 | 200 | 200 | 40 | 0.55 | G5 |
| Example 22 | 200 | 200 | 40 | 0.55 | G5 |
| Example 23 | 200 | 200 | 40 | 0.55 | G5 |
| Example 24 | 200 | 200 | 40 | 0.55 | G5 |
| Example 25 | 200 | 200 | 40 | 0.55 | G5 |
| Example 26 | 200 | 200 | 40 | 0.55 | G5 |
| Example 27 | 200 | 200 | 40 | 0.55 | G3 |
| Example 28 | 200 | 200 | 40 | 0.55 | G3 |
| Example 29 | 200 | 200 | 40 | 0.55 | G5 |
| Example 30 | 200 | 200 | 40 | 0.55 | G5 |
| Example 31 | 200 | 200 | 40 | 0.55 | G5 |
| Example 32 | 200 | 200 | 40 | 0.55 | G5 |
| Example 33 | 200 | 200 | 40 | 0.55 | G5 |
| Example 34 | 200 | 200 | 40 | 0.55 | G5 |
| Example 35 | 200 | 200 | 40 | 0.55 | G5 |
| Example 36 | 200 | 200 | 40 | 0.55 | G5 |
| Example 37 | 200 | 200 | 40 | 0.55 | G5 |
| Example 38 | 200 | 200 | 40 | 0.55 | G5 |
| Example 39 | 200 | 200 | 40 | 0.55 | G5 |
| Example 40 | 200 | 200 | 40 | 0.55 | G3 |

TABLE 6

| | | | | Mass | Dust |
|---|---|---|---|---|---|
| | Kneading | Molding | Mold | ratio of | adhe- |
| | tempera- | tempera- | tempera- | component | sion |
| | ture | ture | ture | (C) | property |
| | (° C.) | (° C.) | (° C.) | (%) | (Grade) |
| Example 41 | 200 | 200 | 40 | 0.55 | G5 |
| Example 42 | 200 | 200 | 40 | 0.58 | G5 |
| Example 43 | 230 | 230 | 40 | 0.55 | G5 |
| Example 44 | 200 | 200 | 40 | 0.58 | G5 |
| Example 45 | 230 | 230 | 40 | 0.60 | G5 |
| Example 46 | 240 | 240 | 40 | 0.63 | G5 |
| Example 47 | 220 | 220 | 40 | 0.56 | G5 |
| Example 48 | 240 | 240 | 40 | 0.64 | G4 |
| Example 49 | 200 | 200 | 40 | 0.51 | G4 |
| Example 50 | 200 | 200 | 40 | 0.58 | G5 |
| Example 51 | 200 | 200 | 40 | 0.52 | G5 |
| Example 52 | 200 | 200 | 40 | 0.59 | G4 |
| Example 53 | 200 | 200 | 40 | 0.51 | G4 |
| Example 54 | 200 | 200 | 40 | 0.55 | G5 |
| Example 55 | 200 | 200 | 40 | 0.53 | G5 |
| Example 56 | 200 | 200 | 40 | 0.55 | G4 |
| Example 57 | 200 | 200 | 40 | 0.52 | G4 |
| Comparative | 200 | 200 | 40 | 0.59 | G2 |
| Example 1 | | | | | |
| Comparative | 200 | 200 | 40 | 0.00 | G1 |
| Example 2 | | | | | |
| Comparative | 200 | 200 | 40 | 1.02 | G1 |
| Example 3 | | | | | |
| Comparative | 200 | 200 | 40 | 0.60 | G1 |
| Example 4 | | | | | |

The foregoing description of the exemplary exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A resin composition comprising:
a cellulose acylate (A);
a thermoplastic elastomer (B); and
metal oxide particles (C).

2. The resin composition according to claim 1,
wherein the thermoplastic elastomer (B) is at least one selected from the group consisting of:
a polymer (b1) having a core-shell structure including a core layer containing a butadiene polymer, and a shell layer containing a polymer selected from a styrene polymer and an acrylonitrile/styrene polymer on a surface of the core layer;
a polymer (b2) having a core-shell structure including a core layer and a shell layer containing an alkyl (meth) acrylate polymer on a surface of the core layer;
an olefin polymer (b3) that is a polymer of an α-olefin and an alkyl (meth) acrylate ester and contains 60 mass % or more of monomers derived from the α-olefin; a styrene-ethylene-butadiene-styrene copolymer (b4); a polyurethane (b5); and a polyester (b6).

3. The resin composition according to claim 1,
wherein the cellulose acylate is at least one selected from the group consisting of a cellulose acetate, a cellulose acetate propionate, and a cellulose acetate butyrate.

4. The resin composition according to claim 2,
wherein the cellulose acylate is at least one selected from the group consisting of a cellulose acetate, a cellulose acetate propionate, and a cellulose acetate butyrate.

5. The resin composition according to claim 3,
wherein the cellulose acylate is at least one selected from a cellulose acetate propionate and a cellulose acetate butyrate.

6. The resin composition according to claim 4,
wherein the cellulose acylate is at least one selected from a cellulose acetate propionate and a cellulose acetate butyrate.

7. The resin composition according to claim 1,
wherein a content of the metal oxide particles (C) is from 0.1 mass % to 2.5 mass % based on the entire resin composition.

8. The resin composition according to claim 2,
wherein a content of the metal oxide particles (C) is from 0.1 mass % to 2.5 mass % based on the entire resin composition.

9. The resin composition according to claim 3,
wherein a content of the metal oxide particles (C) is from 0.1 mass % to 2.5 mass % based on the entire resin composition.

10. The resin composition according to claim 4,
wherein a content of the metal oxide particles (C) is from 0.1 mass % to 2.5 mass % based on the entire resin composition.

11. The resin composition according to claim 5,
wherein a content of the metal oxide particles (C) is from 0.1 mass % to 2.5 mass % based on the entire resin composition.

12. The resin composition according to claim 6,
wherein a content of the metal oxide particles (C) is from 0.1 mass % to 2.5 mass % based on the entire resin composition.

13. The resin composition according to claim 1,
wherein the metal oxide particles (C) contain oxide containing at least one metal selected from the group consisting of Ti, Sn, Fe, Cr, Co, V, Al, Bi, Sb, and Ni.

14. The resin composition according to claim 2,
wherein the metal oxide particles (C) contain oxide containing at least one metal selected from the group consisting of Ti, Sn, Fe, Cr, Co, V, Al, Bi, Sb, and Ni.

15. The resin composition according to claim 3,
wherein the metal oxide particles (C) contain oxide containing at least one metal selected from the group consisting of Ti, Sn, Fe, Cr, Co, V, Al, Bi, Sb, and Ni.

16. The resin composition according to claim 4,
wherein the metal oxide particles (C) contain oxide containing at least one metal selected from the group consisting of Ti, Sn, Fe, Cr, Co, V, Al, Bi, Sb, and Ni.

17. The resin composition according to claim 1,
further comprising a plasticizer (D).

18. The resin composition according to claim 17,
wherein the plasticizer (D) contains at least one selected from the group consisting of a cardanol compound, a dicarboxylic acid diester, a citrate, a polyether compound having at least one unsaturated bond in the molecule, a polyether ester compound, a glycol benzoate ester, a compound represented by the following General Formula (6) and an epoxidized fatty acid ester, 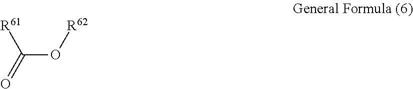
wherein,
in the General Formula (6), R⁶¹ represents an aliphatic hydrocarbon group having 7 to 28 carbon atoms, and R⁶² represents an aliphatic hydrocarbon group having 1 to 8 carbon atoms.

19. A resin molded article, comprising the resin composition according to claim 1.

20. The resin molded article according to claim 19,
wherein the resin molded article is an injection molded article.
